(19) United States
(12) Patent Application Publication
(10) Pub. No.: US 2004/0243672 A1
(43) Pub. Date: Dec. 2, 2004

(54) System and method for user interaction in a peer-to-peer environment

(76) Inventors: Outi Markki, Espoo (FI); Timo Vesalainen, Helsinki (FI); Antti Aaltonen, Tampere (FI)

Correspondence Address: MORGAN & FINNEGAN, L.L.P., 3 WORLD FINANCIAL CENTER, NEW YORK, NY, 10281-2101, US

(21) Appl. No.: 10/446,576

(22) Filed: May 27, 2003

(51) Int. Cl. G06F 15/16

(52) U.S. Cl. 709/204

(57) ABSTRACT

Systems and methods applicable, for example, to searching for entities reachable via networking, allowing for communications among node users, and performing sharing operations. Additionally, systems and methods applicable, for example, in allowing users to easily employ network-capable nodes for various services. Such systems and methods could for example, be employed in the provision of services such as sharing, messaging, and/or chat.

### FIELD OF INVENTION

This invention relates to systems and methods for user interaction, more particularly to such in a peer-to-peer environment.

### BACKGROUND INFORMATION

In recent years, there has been an increase in the use of computers, such as mobile nodes, for messaging, chatting, and file sharing. For example, many individuals have come to rely upon chat and messaging services in preference to conventional mail for textually-related communications. Similarly, many individuals have come to prefer file sharing to conventional venues for receiving content such as record stores, software stores, radio, television, and movie theaters. Moreover, the computers, such as mobile nodes, offer capabilities to individuals to create and edit digital content items (e.g., images, video clips, audio recordings and the like) by themselves. In many cases individuals, would like to share these digital items with other individuals with file sharing technologies.

Accordingly, there may be interest in technologies that facilitate such use of computers.

### SUMMARY OF THE INVENTION

According to various embodiments of the present invention, there are provided systems and methods applicable, for example, to searching for entities reachable via networking, allowing for communications among node users, and performing sharing operations.

Additionally provided are systems and methods applicable, for example, in allowing users to easily employ network-capable nodes for various services.

Such systems and methods could for example, be employed in the provision of services such as sharing, messaging, and/or chat.

### BRIEF DESCRIPTION OF THE DRAWINGS

FIG. 1 is a diagram depicting exemplary steps involved in finding nodes providing information about groups according to various embodiments of the present invention.

FIG. 2 is a diagram depicting exemplary steps involved in search according to various embodiments of the present invention.

FIG. 3 is a diagram depicting exemplary steps involved in making entities available according to various embodiments of the present invention.

FIG. 4 is a diagram depicting exemplary steps involved in messaging according to various embodiments of the present invention.

FIG. 5 shows an exemplary group membership certificate according to various embodiments of the present invention.

FIG. 6. is a diagram depicting exemplary steps involved authentication according to various embodiments of the present invention.

FIG. 7 is a diagram depicting further exemplary steps involved authentication according to various embodiments of the present invention.

FIG. 8 shows various exemplary graphical user interface (GUI) screens relating to a user viewing entities that she has made available for receipt by other nodes.

FIG. 9. shows various exemplary GUI screens relating to various operations performable by a user with respect to entities.

FIGS. 10 and 11 show various exemplary GUI screens relating to entity search operations performable by a node's user.

FIGS. 12 and 13 show various exemplary GUI screens relating to instant messaging operations performable by a node's user.

FIG. 14 shows various exemplary GUI screens relating to group creation.

FIG. 15 shows various exemplary GUI screens relating to searching for groups.

FIG. 16 shows various exemplary GUI screens relating to searching for users and/or corresponding nodes.

FIG. 17 shows various exemplary GUI screens relating to joining a group.

FIG. 18 shows an exemplary general purpose computer employable in various embodiments of the present invention.

FIG. 19 shows a functional block diagram of an exemplary node employable in various embodiments of the present invention.

### DETAILED DESCRIPTION OF THE INVENTION

General Operation

According to various embodiments of the present invention, there are provided systems and methods applicable, for example, in the provision of various services such as sharing, messaging, and chat in a peer-to-peer environment. The services are applicable, for example, among users forming groups in the peer-to-peer environment. The peer-to-peer environment can, for example, be a network in which each participant node has equivalent capabilities and/or responsibilities. Such differs from general client/server architectures, in which some computers are dedicated to serving the others.

In various embodiments, communication between nodes in a peer-to-peer environment can take place via one or more intermediate nodes belonging to the same peer-to-peer environment. The peer-to-peer environment might, for instance, consist of users' nodes and service providers' nodes. It is noted that, in various embodiments, messaging can be implemented via application layer routing between nodes.

In various embodiments, connections between nodes can be maintained, for example, at the application layer (Open System Interconnect level 7). It is noted that, where there is a direct, single hop link between two nodes belonging to one or more common groups, such may be employed in various embodiments. It is further noted that different physical media and different lower layer networking technologies can be used to form connections between nodes in various embodiments. Moreover, it is noted that various embodiments of the present invention provide a peer-to-peer environment employing middleware and/or communications applications enabling, for instance, group collaboration and/or communication.

As noted above, embodiments of the present invention provide various services. Such services could, for example, be made available to users having nodes such as wired or wireless terminals. Such terminals could have one or more network interfaces. The interfaces could be, for instance, Bluetooth, 802.11b, 802.11g, GPRS (General Packet Radio Service), EDGE (Enhanced Data rate for Global System for Mobile communications Evolution), UMTS (Universal Mobile Telecommunications Service), DVB-T (Terrestrial Digital Video Broadcast), DVB-X, and/or Ethernet interfaces.

In various embodiments of the present invention, messages can be passed between nodes, for example, for the provision of the above-mentioned services. Further, various embodiments of the present invention provide user interfaces applicable, for example, to the provision of such services.

Incorporated herein by reference are the co-pending U.S. applications entitled “System and Method for Services Provision in a Peer-To-Peer Environment” and “System and Method for Message Handling in a Peer-To-Peer Environment”, both of which were filed on the same date as this application, list inventors Outi Markki and Timo Vesalainen, and are assigned to Nokia Corporation.

Various aspects of the present invention will now be discussed in greater detail.

Group Join Operations

According to various embodiments of the present invention, a user wishing to join groups and/or make use of various available services may first act to sign-up. For example, such a user might, in various embodiments, visit a kiosk, customer service location, or the like. As another example, such a user might, in various embodiments, direct her node to a web portal or the like. The user could be prompted by a customer representative at a kiosk or the like, or by a web portal or the like, to provide necessary billing information, personal information, and or the like. The customer representative could ask for some metadata to be associated with the user's node. For example, the representative could verbally ask for such data, the user could reply verbally, and the representative could enter the data into a PC or the like. As another example, the representative could have the user answer a series of questions presented using a PC or the like. In various embodiments, the metadata could be checked by one or more service providers.

It is noted that, in various embodiments, the representative may act to have authentication performed with respect to the user and/or her node. Further, it is noted that, in various embodiments, the user may be requested to agree to behave in a legal manner, and/or according to one or more established behavior policies.

As a next step, appropriate software modules or the like could be placed on the user's node, if not being already pre-installed (e.g., by the manufacturer of the node). The appropriate modules might, for instance, include modules corresponding to an application for the user's node, initial default configurations, and/or information regarding service providers and/or nodes corresponding to one or more peer-to-peer environments. The initial default configurations, might, for instance, correspond to initial settings regarding user's node. The information regarding nodes could include, for instance, information regarding public groups and/or a listing of nodes providing name-to-address mapping.

Placing of software modules might, for instance occur via network download via the web portal or via the action of the customer representative. Accordingly, the customer representative might, as a specific example, act to have the software modules delivered to the node via OBEX Object Push Profile (OPP), perhaps over Bluetooth, IRDA, 802.11b, 802.111g, GPRS, EDGE, UMTS, or the like. When the appropriate software modules are activated for the first time, secret keys and/or public keys could, in various embodiments, be created in user's node, perhaps via various techniques known in the art.

In various embodiments, further to the software modules, one or more certificates could be delivered to the node. For instance, a “general access certificate” could be presented, and/or the user could be considered a member of a “general group”. The general access certificate could, for instance, give user the rights to use services offered in the general group. The user rights could include, for example, rights to search metadata information for public groups. As another example, the user rights could include rights to search metadata information regarding general group members and/or their nodes.

As a next step, metadata might, in various embodiments, be associated with the user's node. Such functionality could be implemented in a number of ways. For example, the user's node could query the user for such information via a GUI (Graphical User Interface) or other interface. In response, the user could supply the requested information via a GUI or other interface and have it dispatched to the node.

As another example, the customer representative could ask for such information and have it dispatched to the node. For example, the representative could verbally ask for such data, the user could reply verbally, and the representative could enter the data into a PC or the like. As another example, the representative could have the user answer a series of questions presented using a PC or the like. In either case, the representative could then act to have the metadata dispatched from the PC or the like to user's node.

As a next step, the user might act to employ the software modules to learn of one or more groups that she could join. The software modules delivered to the user's node during initial download could, for instance, contain initial information of nodes to be contacted in dispatching an information request regarding groups that the user could potentially join. Accordingly the user might act to have her node learn of nodes capable of providing such information. It is noted that, in various embodiments, dedicated nodes could exist for providing such information about groups. Alternately or additionally, such information could be provided by nodes that also served other functions. For instance, in various embodiments such information might be provided by various nodes associated with users.

For example, in various embodiments, the user could act to have her node make use of service discovery to learn of such nodes. The service discovery could be, for instance, Bluetooth service discovery or DNS-SD (Domain Name Server Service Discovery). It is noted that mDNS (multicast Domain Name Server) might be employed, for instance, in embodiments employing DNS-SD. As another example, the node might act to broadcast on established and/or well-known ports, and/or to listen on established and/or well-known ports. As yet another example, in various embodiments, the user could act to have her node dispatch a query to learn of nodes that provided such information. Such a query could, for example, be sent via email, MMS (Multimedia Messaging Service) messaging, SMS (Short Message Service) messaging, OBEX OPP (Object Push Profile), messaging via a network formed of nodes, and/or the like. Messaging via the network of nodes might be via peer-to-peer and perhaps, when available, direct links. In various embodiments, such a query could include metadata and/or other parameters indicating that the entities to be found via the search were nodes that provided information about groups joinable by the user.

In various embodiments, the user might be able to indicate to her node via a GUI or other interface a desire to find such nodes providing information about groups. In response to the request, the user's node could, for instance, perform such device discovery and/or dispatch one or more queries of the sort just noted, the queries containing the appropriate metadata and/or other parameters.

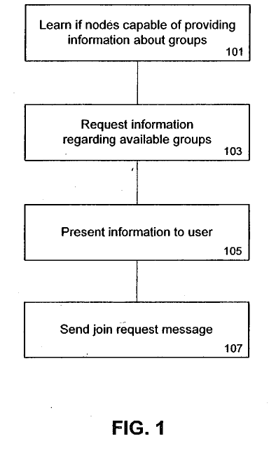

With respect to FIG. 1 it is noted that via, for instance, such query or service discovery, the user's node could learn of nodes capable of providing the desired information (step 101). For example, via such device discovery the user's node could learn of network addresses corresponding to the nodes capable of providing the information. As another example, where a query was sent, the user's node could receive one or more messages containing information regarding the nodes capable of providing the information. Included in each such message could, in various embodiments, be metadata and/or other parameters corresponding to the nodes capable of providing the desired information. In various embodiments, the metadata and/or other parameters corresponding to each node could include unique identifiers and/or be otherwise sufficient to identify that particular node. It is noted that, in various embodiments, unique identifiers could be associated with, for instance, groups, nodes, users, entities, and/or the like.

In response to learning of information regarding the nodes capable of providing group information, the user's node could, in various embodiments, act to present such information to its user via a GUI or other interface. The GUI or other interface could further act to allow the user to select from the presented nodes one or more nodes from which to receive group information. It is noted that, in various embodiments, a user could perform operations, including, for instance, group search operations, via a webpage. Such a webpage might be implemented, for example, via ASP (Active Server Pages), ASP+ (Active Server Pages+), JSP (Java Server Pages), PHP (PHP: Hypertext Preprocessor), WebObjects, and/or the like.

The user's node could next, in compliance with any user specification of the sort just described, request from one or more of the appropriate nodes information regarding available groups (step 103). In various embodiments, the user might, perhaps via a GUI or the like, employ her node to indicate that she was only interested in receiving information regarding groups matching indicated metadata. Where the user supplied such metadata, the metadata could be included in the request. In accordance with embodiments of the present invention, a wide variety of metadata could be specifiable. To provide some specific, non-limiting, examples, it is noted that among specifiable metadata could be a subject of a group, a name of a group, a creator of a group, and/or the like. In various embodiments, a user could be able to enter text mode keywords describing a group. The keywords could, for instance, contain textual information that the user considered relevant in finding a group. Such keywords could perhaps be text describing the subject of the group, name of the group, and/or the like.

Request functionality could be implemented in a number of ways. For example, in various embodiments, the user's node could employ email, MMS messaging, SMS messaging, OBEX OPP, messaging via a network formed of nodes, and/or the like to request such information. Messaging via the network of nodes might be via peer-to-peer and perhaps, when available, direct links. Such action might, for example, be directed to a network address, unique identifier, or the like obtained by the user's node via its above-described actions to receive information regarding nodes capable of providing information regarding available groups. In certain embodiments, multicast could be employed.

In response to receiving a request from information regarding available groups, a node capable of providing such information could act to comply with the request. Accordingly, such a node could act to return a message to the user's node containing the appropriate information. With respect to each group, among the appropriate information could be, for instance, metadata corresponding to the group. Among the metadata could be, for example, the name of the group, a description of the group, indication of group membership criteria, and/or contact information regarding certain individuals associated with the group. The individuals could, for instance, be the managers of those groups and/or be individuals capable of granting access to the group where application was required.

Where metadata was supplied by the user, the node could act to provide information regarding only groups whose associated metadata matched the supplied metadata. It is noted that, in various embodiments, the metadata corresponding to a group could include membership criteria and/or an information relating to a group application to be completed in order to request group membership. As a specific example, there might be three types of group applications (e.g., short, normal, and long), and the metadata could impart which of these was to be employed. Group applications will be discussed in greater detail below. It is noted that, in various embodiments, in acting to provide information regarding only appropriate groups, the node might perform operations involving, for instance, metadata analysis, text analysis, and/or the mapping of, for example, keywords against certain metadata fields. The certain metadata fields might, for instance, be those determined and/or indicated to be most relevant. Such indication might, for example, be done by a system administrator or the like.

Messages responding to requests for information regarding available groups could be sent in a number of ways. For example, such a message could be sent via email, MMS messaging, SMS messaging, OBEX OPP, messaging via a network formed of nodes, and/or the like. Messaging via the network of nodes might be via peer-to-peer and perhaps, when available, direct links. Such action could be directed to a network address or the like of the user's node. Such a network address or the like might, for example, have been received via the request for group information.

It is noted that, in various embodiments, such a message containing group information could be received by a user's node without the node making a corresponding request. For example, a member of a group and/or the group's manager might act to have such information sent without there being a specific request. Such action might be performed, for instance, with the goal of increasing group membership. Such a message could, in various embodiments, contain an invitation to a group, the invitation perhaps including software modules and/or descriptions activating appropriate software modules or the like in user's node without requiring user to do any specific actions. The user's joining a group might be complemented by the user accepting the sent invitation, perhaps via an interface provided by her node. As a specific, non-limiting example, an invitation could be a gaming invitation shown by a gaming application, with the user perhaps accepting the invitation via an interface associated with the gaming application.

In various embodiments, one type of group could be a group of a user's own nodes that is used to enable sharing, uploading, searching and/or downloading files between those terminals. In this kind of group, a user's node might, for instance, do comparisons of group membership metadata of other users' nodes. Based on this comparison, a list might be formed of those groups to which certain of the user's nodes belonged, but the other did not. This list might be used, for instance, to synchronize group memberships among the user's terminals, the user's confirmation perhaps being requested in order to initiate further group application requests. Another way to manage group memberships of a particular user's nodes could involve that user applying delegate manager rights with to one node such that the node could then further grant group memberships to other nodes of the user.

After receiving group information, the user's node could, in various embodiments, act to present such information to its user via a GUI or other interface (step 105). The GUI or other interface could act to allow the user to indicate a desire to join one or more of the groups for which information is presented. In response to its user making such a selection, the user's node could act to send a join request message to an appropriate target (step 107). The appropriate target could be, for example, as specified in received contact information regarding the selected group. In various embodiments, included in a join request message could be unique one or more identifiers corresponding to the user, and/or one or more unique identifiers corresponding to the one or more groups.

In a manner analogous to that discussed above, the join request message could be sent, for example, via email, MMS messaging, SMS messaging, OBEX OPP, messaging via a network formed of nodes, and/or the like, directed according to the corresponding received contact information. Messaging via the network of nodes might be via peer-to-peer and perhaps, when available, direct links.

Upon receipt of the join request message at the appropriate node, the appropriate node might, in various embodiments, access an associated metadata directory, store, and/or the like to consult group rules. Such group rules could, in various embodiments, be established by a group manager and/or the like. In various embodiments, a service provider may act as a group manager for one or more groups. In such embodiments, software modules operating one or more nodes associated with the service provider might allow the service provider to limit membership in those groups to its own customers. In consulting the group rules, the node might first act to see if the join request could possibly be answered affirmatively. As specific examples, the group rules could be consulted to see if there were room for any more members in the group.

Further handling of the join request could happen via automatically, perhaps via software modules of the appropriate node. Another case is that the appropriate node notifies the group manager or the like having rights to grant group membership, perhaps via the node's GUI, of the received join request.

The appropriate node or the group manager may also consult some external database or registers to see if the user corresponding to the join request was potentially eligible for membership, and/or the like. Such eligibility might, for example, involve the user's being associated with a certain region, indicating a proof of a membership in a hobby group, club, and/or the like, and/or being able to share a common secret used as a group membership criteria. This consulting could, in various embodiments, happen based on the user's join request and/or later based on user data received in a membership application.

In the case where it was determined that the user could not potentially be granted membership, a rejection message could be dispatched to the user's node. In a manner analogous to that discussed above, the message could be sent, for example, via email, MMS messaging, SMS messaging, OBEX OPP, messaging via a network formed of nodes, and/or the like. Messaging via the network of nodes might be via peer-to-peer and perhaps, when available, direct links. Where it was found that the user could potentially be granted membership, the group rules could be further consulted to see if a user needed to complete a group application in order to request membership.

In the case where no such application was required, the user could be granted membership. Accordingly, a message indicating that membership had been granted. In a manner analogous to that discussed above, the message could be sent, for example, via email, MMS messaging, SMS messaging, OBEX OPP, messaging via a network formed of nodes, and/or the like. Messaging via the network of nodes might be via peer-to-peer and perhaps, when available, direct links. In various embodiments, included in the message is a certificate corresponding to group membership.

In the case where an application was required, data corresponding to the application could be sent to the node of the user seeking membership. In a manner analogous to that discussed above, the message could be sent, for example, as a join-request-rejected message sent via a network formed of nodes, via email, via MMS messaging, via SMS messaging, via OBEX OPP, and/or the like. Messaging via the network of nodes might be via peer-to-peer and perhaps, when available, direct links. It is noted that, in various embodiments, the application could ask for billing information (e.g., credit card information).

The data corresponding to the application could take a number of forms. For example, the data could take the form of a hyperlink to a secure website that could present the application and forward the results to the node that dispatched the message including data corresponding to the application. The secure website might, for example, employ SSL (Secure Socket Layer) or TLS (Transport Layer Security). As another example, the data could take the form of an Java or .Net application that, when run at the recipient's node, could present the application and forward the results to the node that dispatched the message including data corresponding to the application. In either case, forwarding of the results could, for example, in a manner analogous to that described above, employ email, MMS messaging, SMS messaging, OBEX OPP, messaging via a network formed of nodes, and/or the like. Messaging via the network of nodes might be via peer-to-peer and perhaps, when available, direct links. As an alternative, SOAP (Simple Object Access Protocol), RMI (Remote Method Invocation), JMS (Java Messaging Service), and/or the like might be employed.

Upon receipt of the forwarded results, the recipient node could act to see if the results were in accordance with those needed for grant of group membership. Such determination could, for example, involve comparing the results with the above-noted group rules. Alternately or additionally, such determination could involve commutation with one or more servers or the like in order to confirm billing data or the like requested by the application. Such one or more severs might, for example, be servers operated by a bank, credit card company, or the like. Where it was determined that membership could not be granted to the user, a rejection message could be dispatched as discussed above. Where it was determined that membership could be granted, a message indicating that membership had been granted could be dispatched as discussed above.

It is noted that, in various embodiments, corresponding to a user could be metadata of the sort discussed above as being collected, for example, by a customer representative, and/or metadata relating to that user's membership in a group. In various embodiments, the former sort of metadata could be shared among all subscriber nodes, and perhaps not be alterable by the user, while the later sort of metadata might only be shared if specified by the user.

Search Operations

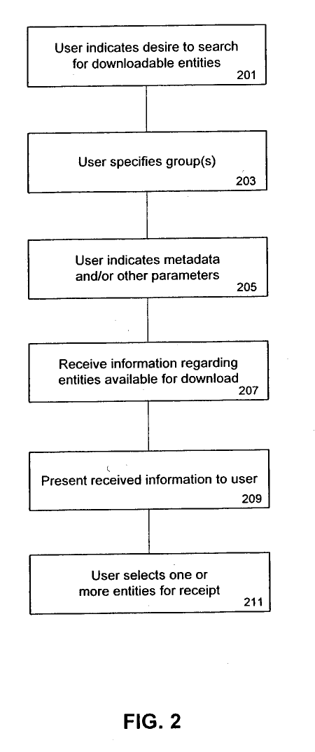

With respect to FIG. 2 it is noted that a node user wishing to search for information regarding groups, other group members, downloadable entities such as a files, media items, program, and/or the like could, according to various embodiments of the present invention, indicate a desire to do so via a GUI or other interface provided by her node (step 201). In various embodiments, the user could additionally specify one or more of her node's network interfaces as employable in the searching for and/or downloading entities.

Further there may, in various embodiments, be specifications seeking to optimize and/or minimize the use of particular network interfaces and/or link types. As a specific example, it might be specified that the node should act to minimize the use of cellular telephone links such as, for example, GPRS or UMTS links and maximize the use of short-range radio communication links such as, for example, Bluetooth links. Such specification regarding usage of network interfaces might, in various embodiments, have been done via communication settings of user's node related to, for instance, appropriate software modules.

Such appropriate software modules included in various embodiments might, for example, be one or more software modules operating on a node to control which connections with other nodes are kept open. Such decisions could be made based on a number of parameters. For example, such modules might keep track of connection patterns between various nodes. Such modules might then examine such patterns in order to make a guess as to whether a particular connection was to be used in the near future. In the case where a particular connection was guessed to be used in the near future, it could be kept open. Such functionality might have a number of benefits. For instance, reducing the number of connection establishment and/or takedown operations might result in processing and/or energy saving at one or more nodes. In various embodiments, multiplexing could be employed in connections where appropriate such that multiple messages and/or the like could sent between two nodes via a single communication pipe or the like associated with a link.

Operations so performed by such modules or the like could be, for instance, performed with the goal of keeping open an optimum number of connections between the node with which they are associated and other nodes. It is noted that, in embodiments where such software modules or the like are employed, it may only be where it is discovered that there are not enough existing connections to particular other nodes (e.g., nodes belonging to one or more particular groups) that further connections would be sought and/or established. Accordingly, in such embodiments, for example, it may not be necessary to perform operations which seek and/or establish new connections when performing various network operations described herein (e.g., operations related to joining groups, operations related to search, operations relating to sharing, operations relating to messaging, and operations relating to chat). Operations performed by such modules could, in various embodiments, have the effect of reducing wait time experienced by a user.

The communication settings might, for example, have been given to user's node as a default configuration file during initial sign-up, and/or as a later update, the update perhaps having been dispatched via network. Alternately or additionally, the communication settings might have been entered by the node's user, perhaps via an appropriate GUI. Or, as user can define such settings or do selections per a specific operation. Via such entry, the user might, in various embodiments, be able to specify communications settings with respect to specified and/or all network operations and/or the like, and/or on a per-operation basis.

The communication settings might, in various embodiments, cover the overall guidelines of usage of network links and node interfaces regarding communication with other nodes via appropriate software modules. It is further noted that the settings might, in various embodiments, be split to specific settings per an operation type. Accordingly, for example, there might be one setting regarding search requests and/or replies, and another setting for more bandwidth demanding operations, such as, for instance, upload and download of entities.

It is noted that, in various embodiments, users may be costs and/or bandwidths associated with various network operations (e.g., entity uploads, entity downloads, and/or message dispatches). Accordingly, a user could be informed, for instance via a GUI, of the costs she would incur and/or bandwidths she would enjoy in performing a particular network operation. Where multiple hops were involved in a particular network operation, the user could be presented with a total cost and/or average bandwidth. Alternately or additionally, the user could be presented with a cost and/or bandwidth for each hop. Where multiple alternatives are available for performing a network operation (e.g., one path involving a single UMTS hop, and another involving several Bluetooth hops), the user could be presented with cost and/or bandwidth information for each alternative, the presentation perhaps being as just described.

It is noted that, in various embodiments, in displaying information to a user of the sort noted above, presentation could be in such a way that could highlight certain properties. For instance, where multiple alternatives are available to a user for performing a network operation, the user could, in addition to or as an alterative to presentation of the sort just described, be presented with indications as to, for instance, which alterative would cost the least money, which would provide the highest bandwidth, and/or the like.

In various embodiments of the present invention, network operations performed by a user could cause another user to incur costs such as, for example, network use costs. Such could be the case, for example, in certain cases where a user requests an entity that is dispatched via the nodes of one or more other users. Accordingly, functionality might, in various embodiments, be provided whereby a user could be informed of, for instance, the costs she would cause others to incur in performing a particular network operation. The user could be so informed, for instance, in a manner analogous to that just described.

In response, the node could present its user with a listing of the groups of which she is a member, and request that she indicates with respect to which of these groups the search should be performed. The user could make the choice via the GUI or other interface (step 203). As a next step, the user could, in various embodiments of the present invention, choose to indicate to her node metadata keywords, and/or other parameters corresponding to the entities that should be found (step 205). In accordance with certain embodiments of the present invention, a wide variety of metadata could be specifiable. To provide some specific, non-limiting examples, it is noted that among specifiable metadata could be metadata related to groups and group services like chat, metadata related to searched entities like name, size, genre, artist, album, media type, date of creation, date of availability for the group, and/or the like. In certain embodiments, the user could be able to specify that the search be performed periodically. The frequency for such might be selected by the node, and/or could be specifiable by the user. Further, in certain embodiments of the present invention, a user could specify a time and date at which searching should commence. Also, in various embodiments, operations related to a search could be specified to execute on a node at times a user is not interacting with the node. As another example, in various embodiments, a search operation could be specified to be always active. Operations related to such searches could, for instance, execute as a background process, perhaps such that appropriate user interface software modules are not active and the user is not actively doing any effort.

Next, the user's node could, in various embodiments, act to send via already established communication channels one or more messages containing information of downloadable entities corresponding to one of more nodes belonging to selected groups.

Next, the user's node could act to determine the entities available for download with respect to the chosen group or groups and any specification of metadata and/or other parameters. Such functionality could be implemented in a number of ways.

For example, the user's node could then act to send via already established communication channels one or more messages requesting about information of downloadable entities regarding to the one or more nodes belonging to selected groups. If the user's node notices that there are no sufficient communication channels to reach enough nodes in the selected groups, the node could employ service discovery, perhaps of the sort noted above, to learn of nodes associated with the specified groups. Accordingly, the user's node could, via such service discovery, learn of network addresses or the like correspond to those nodes. The user's node could then act to send one or more messages requesting from one or more of those nodes information regarding entities available for download. Included in the request could be any user specification of metadata and/or other parameters. In a manner analogous to that discussed above, each such message could be sent, for example, via email, MMS messaging, SMS messaging, OBEX OPP, sending a dispatch message via a network formed of nodes, and/or the like. Messaging via the network of nodes might be via peer-to-peer and perhaps, when available, direct links.

As a next step, those nodes could provide the user's node with information regarding entities available for download, and/or could send the request to other nodes in a group in a manner described in co-pending U.S. application “System and Method for Message Handling in a Peer-To-Peer Environment”, which is incorporated herein by reference.

Next, the user's node could receive information regarding entities available for download (step 207). Such information could include, in various embodiments, related unique identifiers, network addresses, and/or the like. Such information could arrive in a number of ways. For example, the information could arrive via messages sent via email, MMS messaging, SMS messaging, OBEX OPP, messaging via a network formed of nodes, and/or the like in a manner analogous to that discussed above. Messaging via the network of nodes might be via peer-to-peer and perhaps, when available, direct links. Included in the received information could be, for instance, metadata and/or other parameters corresponding to the entities available for download. Also included could be, for instance, indications of numbers of network hops, types of networks hops, network use cost information, and/or the like corresponding to receipt of the entities at the user's node.

Next, the node could present to its user, perhaps via a GUI or other interface, all or some of the received information regarding entities available for download (step 209). In various embodiments where the user had provided specifications regarding link and/or interface use, the presentation could be in accordance with the specifications. As a specific example, where the user or setting in the user's node had indicated a desire to minimize the use of cellular links such as, for example, GPRS or UMTS links and maximize the use of short-range radio communication links such as, for example, Bluetooth links, the node might act to only present information regarding entities that could be retrieved in compliance with those specifications. It is noted that in various embodiments a further search results could be requested. For such embodiments, the GUI or other interface could present the user with the option to request such further searching. In the case where the user requested such further searching, the user's node could act as discussed above to comply with the request. Upon receipt of the results of the further searching, the user's node could act, perhaps in a manner analogous to that just described, to present all or some of the received data, and perhaps to again present the option for further searching. The first phase search result presentation might contain surrogates related to content items like thumbnails of images, samples of video clips, document summaries, and/or the like. In certain embodiments it is possible that the search results show the metadata and other descriptions of the found items with the identity of the node holding the entity, with an additional notice that the items themselves are not available since the node is not active or cannot be reached at the moment.

The GUI or other interface could, in various embodiments, further act to allow the user to select from the presented entities one or more entities for receipt (step 211). The user's node could act to request receipt of such selected entities in a number of ways. For example, the user's node could dispatch one or more such requests via email, MMS messaging, SMS messaging, OBEX OPP, messaging via a network formed of nodes, and/or the like. The requests could be directed toward unique identifiers, network addresses and/or the like corresponding to the nodes offering the desired entities. The unique identifiers, network addresses and/or the like might be known, for example, by examination of messages received via email, MMS messaging, SMS messaging, OBEX OPP, messaging via a network formed of nodes and/or the like regarding available entities. As a specific example, the knowledge could be acquired by sending and receiving search and search reply messages. It is noted that messaging via the network of nodes might be via peer-to-peer and perhaps, when available, direct links.

As a next step, the user's node could receive the requested entities. The requested entities could be dispatched to the user's node in a number of ways. For example, the entities could be dispatched by the nodes possessing them via email, MMS messaging, SMS messaging, OBEX OPP, messaging via a network formed of nodes, and/or the like. Messaging via the network of nodes might be via peer-to-peer and perhaps, when available, direct links. In various embodiments, in selecting entities for download, the user could specify a desire to perform a conditional download. For instance, the user might be able to specify that a particular entity only be downloaded when her node is capable of directly contacting the node holding the entity (e.g., via direct Bluetooth communication).

The user's node could act to comply with such a request in a number of ways. For example, where the user's node knew the identity of the node holding the entity, the user's node could periodically perform device discovery in an attempt to find the node holding the entity, and act to have the entity received upon the node holding the entity being so found. As another example, where the search results did not indicate that the entity could be received from a node by a single network hop, the user's node could periodically repeat the search until such a result was found, and then perform operations to receive the entity via the found single hop source. As a specific example, the user's node might perform such searching to discover a source for the entity that involved a single Bluetooth hop. In another alternative embodiment, the entity downloading might be activated once there was a Bluetooth connection from user's node available to other nodes providing access to this node holding the entity.

According to various embodiments, in selecting an entity for download, a user and/or a user's node could specify that different parts of the entity be received in different ways. For example, where the node indicated to the user that a particular entity could be received in two ways, one involving only Bluetooth hops and a second involving only UMTS hops, the user could specify, perhaps via a GUI or other interface, that a first portion of the entity should be receive via the UMTS hops and the remainder of the entity should be received via the Bluetooth hops. In various embodiments, the user and/or the user's node could further specify portion sizes. Accordingly, the user and/or the user's node might be able to specify that the first portion be of a specified size in bytes and/or be a specified fraction of the whole. The first portion might, for instance, be significantly smaller than the remaining portion. The user and/or the user's node might make such specifications, for example, believing Bluetooth to be slower but less expensive, and UMTS to be faster but more expensive, and adopting the point of view that she was willing to incur the expense to get the first part (e.g., so that she could begin making use of the entity), but was willing to wait longer to receive the rest.

As a specific example, the portion sizes might be chosen such that by the time the user had made use of the first portion of the entity, the other portions would have already arrived. It is noted that entities such as, for example, media items like sounds, films, and/or the like could offer functionality whereby one could view a portion of the entity without possessing the whole.

In various embodiments retransmission of an entity not wholly received (e.g., due to network errors) could be such that correctly-received portions of the entity are not resent.

In the case where the user's node, rather than the user, specifies that different parts of an entity should be received in different ways such functionality might, perhaps, be in accordance with guidelines for operation. The guidelines might, for example, be based on preferences set by the node's user (e.g., via a GUI) and/or be based upon default settings. The default settings might, for example, be loaded upon the node during initial set-up and/or placed thereupon at a later time (e.g., via network transfer of appropriate data). In various embodiments, the default settings might be provided by a service provider, system administrator, and/or the like.

The functionality whereby a node specifies that different parts of an entity be received in different ways might, in various embodiments, be performed by one or more software modules operating on the node. It is further noted that such functionality might be part of an overall functionality implemented by that node with the goal of achieving efficient communications. It is further noted that a node might, perhaps, act in a manner that is tolerant of breaks in connections and/or in availability of various types of links, perhaps being able to easily resume network operations upon a connection being re-created, and/or one or more link types becoming available once again.

Moreover, although it is described in various portions herein that a user may manipulate various settings, in various embodiments a user may not need to manipulate such settings. For instance, it is noted that in various embodiments a user may be provided with a set of default settings for her node providing acceptable operation such that, if the user was not interested in manipulating settings, she still could enjoy the functionality provided by her node described herein. Such default settings might, for example, be provided to her node at time of manufacture and/or initial sign-up. It is further noted that, in various embodiments, a user may be able to place settings, for example when taking possession of her node for the first time, and then update those settings periodically and/or by her own volition.

Additionally, it is noted that, in various embodiments, a user need not wait for various network operations described herein (e.g., operations related to joining groups, operations related to search, operations relating to sharing, operations relating to messaging, and operations relating to chat) to complete before doing something else with her node. Accordingly, a user could act to move to another part of the application running on her node or alternately to another application, have another network operation performed, and/or the like while one or more network operations described herein are done, for instance, as a background process or the like. The user might, in various embodiments, receive and/or request status for and/or notification of completion of such one or more network operations, for instance, acting as background processes. Such status and/or notification might, for instance, be presented in a non-disturbing manner (e.g., via presentation of small icons, the icons perhaps being associated with a status bar or the like).

Sharing Operations

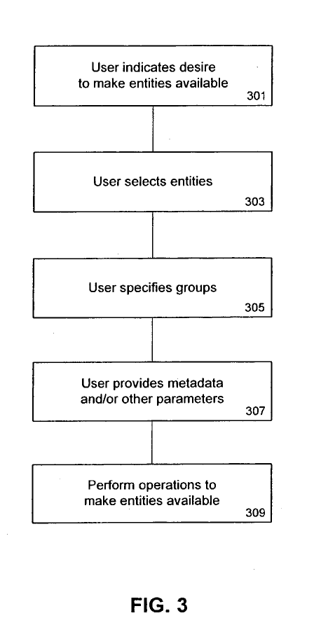

With respect to FIG. 3 it is noted that a user wishing to make entities such as files, media items, programs, folders (e.g., including a plurality of entities), and/or the like available from her node for receipt by other nodes could, according to various embodiments of the present invention, first indicate a desire to do so to her node via a GUI or other interface (step 301). In response, her node could allow the user to select one or more entities to be made available. Such functionality could be provided in a number of ways. For instance, the user could be allowed to navigate through the node's file system via a GUI or other interface and to select those entities to be shared (step 303).

Next, for each selected entity, the node could, in various embodiments, query the user as to which groups the entity should be made available for download. For example, the node could provide for each entity a GUI checkbox or the like corresponding to each group allowing for downloads of which the user was a member (step 305). Further for each selected entity, the node could, in various embodiments, prompt the user for corresponding metadata and/or other parameters (step 307). In certain embodiments, the node might not perform such an operation in the case where it determined that metadata and/or other parameters were already associated with an item. In various embodiments metadata and/or other parameters associated with an entity could include a unique identifier. Accordingly, the node might next act to create a unique identifier corresponding to each selected entity and to append it to the entity's metadata. Unique identifier creation could be performed in a number of ways. For example, random number generation and/or one or more equations could be employed in the creation.

In various embodiments, the node might, in various embodiments, next act to copy the selected entities to one or more appropriate folders on the node associated with file sharing. In another embodiment, instead of the selected entity itself being copied, a link to the entity (e.g., file), and/or perhaps corresponding metadata and/or other information, could be copied. For instance, the node might maintain such a folder with respect to each group for which its user is a member and is making entities available for download. As a next step, the node could perform operations to make the selected entities available for download (step 309). Such functionality could be implanted in a number of ways.

Further, the node could, in various embodiments, perform appropriate operations to allow service discovery operations of the sort described above to find it to be providing items for download. Further, the node could perform appropriate operations to prepare itself to respond, perhaps in accordance with that discussed above, to messages requesting information regarding entities available for download. As noted above such messages might, for instance be received via email, MMS messaging, SMS messaging, OBEX OPP, messaging via a network formed of nodes, and/or the like. Messaging via the network of nodes might be via peer-to-peer and perhaps, when available, direct links.

In various embodiments a node could act to receive an entity or entity portion for the purpose of passing it on to another node, and such entities or entity portions could be cached with a unique identifier and made available for further downloads by other nodes belonging to any of the peer-to-peer groups. It is further noted that a node could act to decide whether or not to perform such caching based, for example, on specifications regarding available storage space. It is still further noted that, in various embodiments, entities or entity portions could be provided via multicast in cases where such functionality is appropriate.

Additionally, it is noted that, in various embodiments, a user could act to deny search request and/or item receipt requests arriving at her node. The user might be able to make such specification, for instance, via a GUI or other interface provided by her node. Various forms of such functionality could be provided to users. For example a user might be able to specify that all search and/or item requests should be denied. As another example, a user might be able to specify that all search and/or item requests matching specified parameters be denied. As yet another example, a user might be able to specify that she be informed by her node of each incoming search and/or item request and be provided with the option of allowing or denying it. In various embodiments, differing amounts and types of information could be presented to the user by her node in the process of so informing her of an incoming request.

In various embodiments it might be possible to define, perhaps via an interface of a user's node, how entity sharing will happen once an entity is marked to be shared. For example, a user wanting to avoid extra costs, and/or excess processor use, power use, bandwidth use, and/or the like related to usage of her node's access link might specify that uploading of files and/or metadata describing those files should be minimized. Different combinations of optimization techniques can be utilized.

As a specific example, an entity is marked to be shared, replicas of the entity's metadata and/or the entity itself could, in various embodiments, be transferred to other nodes belonging to the appropriate group. Those nodes could, for instance, be other users nodes or nodes of a service provider. Such operation could have benefits such as, for example, improving availability of shared entities and/or information regarding shared entities in, for instance, the case of users nodes and/or appropriate software modules not being always active and/or reachable. As another example, such operation could have the benefit of enabling sharing in cases the user does not allow searches and/or download request to be satisfied by her node.

In various embodiments, the transferring of replicas of the entity's metadata and/or the entity itself to other nodes may take into consideration also cost and bandwidth issues relating to sharing of data. These issues may be taken into consideration, for example, be sending the data between nodes through a short-range radio link (e.g., wherein the nodes are positioned in closed proximity to each other).

In another example, once a node receives a search request, then the node could, in various embodiments, act to determine whether it possesses the requested entity and/or any other entities corresponding to, or with a close match to, the requested entity. Thereafter, in various embodiments, the node could dispatch the search reply and add descriptive metadata describing the entity to the reply. The metadata or part of it, including for example the unique identifier and/or network address of the node, and/or the unique identifier of the entity itself, might, in various embodiments, be copied to caches of intermediate nodes transporting the search reply to the requesting node. The actual search reply delivered to the requesting node might, perhaps, contain only a subset of uploaded metadata description. As a specific example, later on, when some other node sends a similar or corresponding query, it may happen that one or more intermediate nodes are able to provide the requested entity, so the query does not need to be routed to the node having the entity. Some of the intermediate nodes may be always on-line and/or possess large caches. However, if the metadata in the caches of intermediate nodes has been aged, the reply procedure may need to be repeated.

It is noted that, in various embodiments, the upload of an entity by a node to other nodes might happen only when the node receives a first request regarding that specific item. In such embodiments, in the case of a first request, the entity could be uploaded, and perhaps copied to caches of other nodes and/or linked with the already uploaded metadata. It is noted that, in such embodiments, in the case where no upload request was ever received, the entity might never be moved over the access link.

Messaging Operations

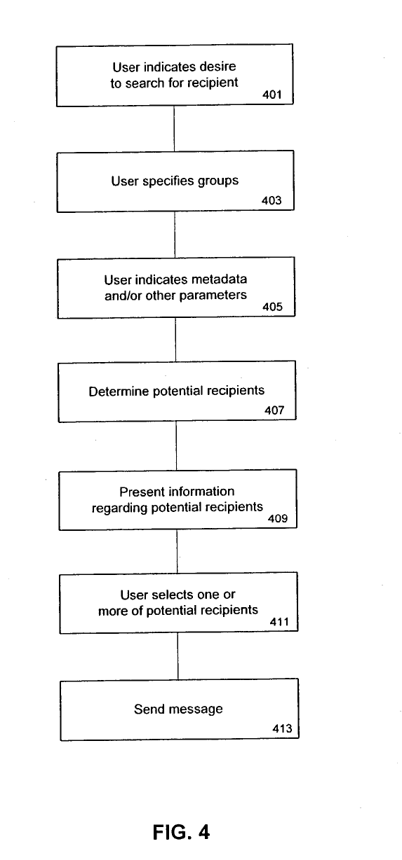

With respect to FIG. 4 it is noted that a node user wishing to send an instant message could, according to various embodiments of the present invention, indicate a desire to search for a corresponding recipient via a GUI or other interface provided by her node (step 401). In various embodiments, the user could additionally specify one or more of its node's interfaces as employable in the searching for instant messaging recipients and/or sending instant messages.

In response, the node could present its user with a listing of the groups of which she is a member, and request that she indicate of which one or more of these groups the recipient of her instant message should be a member. The user could make the choice via the GUI or other interface (step 403). As a next step, the user could, in various embodiments of the present invention, choose to indicate to her node metadata and/or other parameters corresponding to potential recipients that should be found (step 405). Next, the user's node could act to determine potential recipients with respect to the chosen group or groups and any specification of metadata and/or other parameters. Such functionality could be implemented in a number of ways (step 407).

For example, the node could employ service discovery, perhaps of the sort described above, to learn of potential recipients associated with the specified groups. Accordingly, the user's node could, via such service discovery, learn of unique identifiers, network addresses, and/or the like corresponding to the nodes of those potential recipients. In various embodiments, through such discovery the user's node could learn of metadata and/or other parameters corresponding to potential recipients, and only consider those potential recipients whose metadata and/or other parameters matched any such indicated by its user. Next, the node could present to its user, perhaps via a GUI or other interface, all or some of the received information regarding potential recipients (step 409).

It is noted that, in various embodiments a further search results could be requested by the user. For such embodiments, the user's node could operate in a manner analogous to that discussed above with respect to search for entities such as content items. It is further noted that, in various such embodiments, the user's node might automatically act to receive further search results, perhaps in an attempt to learn of all relevant potential recipients.

The GUI or other interface presenting potential recipients to the user could further act to allow the user to select one or more of the potential recipients as instant message recipients (step 411). In response to such a selection, the node might first allow the user to compose a corresponding instant message. For instance, the node could present its user with a GUI window or the like into which text could be entered and/or files (e.g., multimedia files or program files) could be dragged.

Next, the user's node could act to send the created message (step 413). Such functionality could be implemented in a number of ways. For instance, the instant message could be dispatched, perhaps in a manner analogous to that discussed above, via email, MMS, messaging via a network formed of nodes messaging, SMS messaging, OBEX OPP, messaging via a network of nodes, and/or the like. Messaging via the network of nodes might be via peer-to-peer and perhaps, when available, direct links.

It is noted that, in various embodiments, a user could specify an instant message recipient without having searching of the sort described above performed. For example, the user's node could present her with a listing of potential recipients that were already known to it. The node might know of such potential recipients by their unique identifiers, network addresses, and/or the like. Such information may be obtained, for example, via previous search operations, previous message send operations, an associated store, and/or the like. As another example, the user might provide its node with information sufficient to have a message sent to a particular user's node. Such sufficient information could include, for instance, a network address, a unique identifier, metadata associated with a unique identifier, and/or the like.

In various embodiments, a user wanting to send a message to all currently active members of a peer group could do so without the need to specify recipients more exactly than via an appropriate common group identifier. In another example, a user wanting to send a message to all currently active members in a peer group could act to select the peer group as recipient, and the user's node could respond, for instance, by mapping the unique identifier of the group to the message.

In accordance with various embodiments of the present invention, the node of a user wishing to receive instant messages might act to perform one or more preparatory steps. For example, the node could perform appropriate operations to allow service discovery operations of the sort described above to find it and/or its user as potential recipients.

Chat Operations

According to various embodiments of the present invention, a user wishing to search for joinable chat boards might indicate a desire to do so via a GUI or other interface provided by her node. In various embodiments, the user could additionally specify one or more of her node's interfaces as employable in the searching for instant messaging recipients and/or sending instant messages. In response, the node could present its user with a listing of the groups of which she is a member, and request that the user indicate with respect to which of these groups she wished to search for chat boards. The user could then comply.

As a next step, the user could, in various embodiments of the present invention, choose to indicate to her node metadata and/or other parameters to be taken into account in searching for joinable chat boards.

Next, the node could act, perhaps in accordance with any user indications of the sort noted above, to learn of one or more nodes handling chat board membership. Such functionality could be implemented in a number of ways. For instance, service discovery, perhaps of the sort described above, could be employed. Through such action, the node could learn of various available chat boards.

In another embodiment of the present invention, the user does not need to search for available chat boards, and the user's node is automatically informed of currently active chat boards in those peer groups where the user is a member and the user's node is online.

As a next step the node could act to present to its user received information regarding available chat boards. Next, the node could allow the user to indicate a desire to join one or more of the chat boards. With respect to each chat board so chosen by the user, the user's node could act to dispatch a message regarding its user's wish to join the board to the appropriate node. Such dispatch could be performed in a number of ways. For example, such dispatch could be via email, MMS messaging, SMS messaging, OBEX OPP, messaging via a network formed of nodes, and/or the like. Messaging via the network of nodes might be via peer-to-peer and perhaps, when available, direct links. Included in the message could be metadata and/or other parameters corresponding to the user, the metadata perhaps including a unique identifier corresponding to the user.

In response, each recipient node could act to add some or all of the metadata and/or other parameters to a maintained store containing data corresponding to all members of the board. Next, each recipient node could act to dispatch to nodes of its current members messages including data corresponding to the user, the data being sufficient to allow the each such node to send messages to the user's node. After this, each recipient node could act to dispatch to the user's node one or more messages including data corresponding to all members of the board, the data being sufficient to allow the user's node to send messages to the nodes corresponding to those members. The recipient nodes could send the messages to the nodes of the current members and the node of the user in a number of ways. For instance, email, MMS messaging, SMS messaging, OBEX OPP, messaging via a network formed of nodes, and/or the like could be employed. Messaging via the network of nodes might be via peer-to-peer and perhaps, when available, direct links.

Next, the user could employ her node to participate in a joined chat board. Accordingly, the node could, for example, employ a GUI or other interface to present to its user joined chat boards and to allow the user to select one or more of the chat boards for participation. For a joined chat board in which the user was participating, the user's node could allow her to, perhaps via the GUI or other interface, view messages or the like posted to the chat board and/or to post messages or the like to the chat board.

In the case where the user wished to post a message or the like to the chat board, the user could employ her node to compose the message. For instance, the user could enter appropriate text and/or drag appropriate files (e.g., multimedia files) into a GUI window. Upon completing composition of the message, user could further indicate to her node that the message be posted. The functionality for performing such posting could be implemented in a number of ways. For example, the user's node could dispatch the message in a manner analogous to that discussed above with respect to instant messaging, but with delivery being to the nodes of all members of the board in accordance with the received data corresponding to those nodes.

The nodes of other members of the chat board wishing to post messages could behave in a like manner. Accordingly, the user's node could be one of the multiple recipients of such a message, and could present it to the user, perhaps via the GUI or other interface noted above.

According to various embodiments of the present invention, a node's user might act to create a new chat board corresponding to a group of which she is a member. In certain embodiments, rules set by a system administrator or other individual could govern whether or a user was allowed to create a new chat board. A user wishing to so create a new chat board might first employ a GUI or other interface to indicate her desire to do so to her node.

In response, the node could, in various embodiments, query the user for metadata and/or other parameters corresponding to the chat board to be created. The node might further query the user for specification of a group with respect to which the chat board should be created. After receiving the user's responses, the node could, where necessary, perform service discovery, perhaps in a manner analogous to that discussed above, to learn of one or more nodes handling chat board membership. Where the node's user indicated a particular group for which the chat board should be created, the user's node could act in the service discovery to learn of one or more nodes handling chat board membership with respect to the indicated group.

Next, the user's node could dispatch to an appropriate node handling board membership a message indicating its user's desire to create a new chat board. Included in the message could be, for instance, metadata and/or other parameters corresponding to the user, metadata and/or other parameters provided by the user regarding the chat board to be created, and/or an indication of the group with respect to which the chat board is to be created. In various embodiments, included in the metadata and/or other parameters may be parameters corresponding to the user such as a unique identifier of the user or the user's node, or the like. In alternative embodiments, included in the metadata and/or other parameters are identifiers of the chipboard or the group. The message could be dispatched, for example, via email, MMS messaging, SMS messaging, OBEX OPP, messaging via a network formed of nodes, and/or the like. Messaging via the network of nodes might be via peer-to-peer and perhaps, when available, direct links.

Upon receipt of the message, the appropriate node could, in various embodiments, first act to see if the user was permitted to create a new chat board. Accordingly, the appropriate node might access an associated store, another node, and/or the like to consult any corresponding rules. In the case where the appropriate node found that the user was not permitted to create a new chat board, it could dispatch a message containing an indication of such to the user's node. The message might be dispatched, for example, via email, MMS messaging, SMS messaging, OBEX OPP, messaging via a network formed of nodes, and/or the like. Messaging via the network of nodes might be via peer-to-peer and perhaps, when available, direct links. Where the appropriate node determined that the user was permitted to create a new chat board, and/or in embodiments where no such determination was performed, the appropriate node could act to establish the new chat board. Accordingly the appropriate node might, for example, perform appropriate operations to allow service discovery operations of the sort described above to result in learning about the newly-created chat board. Alternately or additionally, the appropriate node might, for instance, automatically inform on-line nodes of other group members of the availability of the new chat board, and/or perform appropriate operations so that it could, perhaps in a manner analogous to that discussed above, respond to received messages regarding a user's wish to join the newly-created chart board.

In another example, when a user indicates a desire to create a new chat board via a GUI or the like, software in the user's node could check from metadata describing the user's profile whether the user is entitled to established a new chat board or not.

Game Operations

As discussed above, various of the functionality described herein may be applied, for example, to chat, sharing, and messaging. It is noted that such functionality is applicable to many other uses as well. An exemplary such additional use will now be described.

According to various embodiments of the present invention, there may exist functionality relating to various sorts of gaming. Such functionality could, for instance, allow for multi-player gaming among group members. In various embodiments, all users interested in playing games may belong to general group corresponding to gaming, and/or each might possess a corresponding certificate. Such a gaming general group and/or corresponding certificate could operate in a manner analogous to the general group and corresponding certificate discussed above. In various embodiments, a user belonging to such a gaming general group could search for and/or join various groups corresponding to joinable game instances in progress and/or starting at a later time. For instance, a particular such group might correspond to a game in which members of the group were competing in a virtual motorcycle race. It is noted that, in various embodiments, there might be no gaming general group. For such embodiments, users interested in playing games might be able to search for and/or join groups corresponding to joinable games by way of membership in a general group of the sort noted above.

Accordingly, a user wishing to join in a multiplayer game could act to have a search for groups corresponding to appropriate game instances performed. Such a search for groups could operate in a manner analogous to that discussed above. Thus the user could, perhaps via appropriate GUI elements, supply metadata and/or other information (e.g., freely written text based keywords, other types of information, and/or the like) describing the sort of game she was interested in joining. For example, the user could supply the name of a game she was interested in as title metadata, and perhaps further supply qualifying data as subject field metadata. Alternately or additionally, the user could supply such information via freely written text based keywords, other types of information, and/or the like.

In response, the user's node could act to process the user's entry. In various embodiments, the user's node might act, perhaps in a manner analogous to that discussed above, to associate freely written text based keywords, other types of information, and/or the like could with appropriate metadata values, fields, and/or the like. Next, the user's node could act to perform appropriate operations so as to have search performed for groups in accordance with the user's entries. Such operations could, for example, be performed in a manner analogous to that discussed above. It is noted that, in various embodiments, the user's node might add parameters to a message or the like sent in carrying out the appropriate operations. Such parameters might, for instance relate to node type, a node identifier, and/or the user (e.g., user alias name). It is further noted that, in performing the operations, the node might, in various embodiments, make use of already-open connections to other nodes. Such connections might, for instance, involve messaging via a network formed of nodes. Messaging via the network of nodes might be via peer-to-peer and perhaps, when available, direct links. The connections could, in various embodiments, involve the use of different types of transmission links.

In response to the appropriate operations performed by the node in response to its user's request to search for groups corresponding to joinable games, various information could be received. For instance, various metadata and/or other information relating to the groups could be received. Among the information received could be descriptions, invitations, challenges, and/or the like. Such could be presented to the user, for instance, via appropriate GUI elements or the like. Received, for example, with respect to a group could be a challenge directed towards players interested in joining an in progress virtual motorcycle race. As another example, received with respect to a group could be a challenge directed towards players interested in joining a virtual motorcycle race set to start at an indicated time.

The user could next indicate a desire to join one of the groups corresponding to joinable games, and her node could act to comply with her request. Such functionality could operate, for instance, in a manner analogous to that discussed above. In various embodiments, in the case where the user's node did not possess appropriate program modules and/or the like corresponding to the game to be played, operations might be performed so that the node could receive the appropriate modules and/or the like. For instance, such appropriate modules and/or the like might be delivered by messaging via a network formed of nodes. Messaging via the network of nodes might be via peer-to-peer and perhaps, when available, direct links.

As noted above, in various embodiments of the present invention a message containing group information could be dispatched to other users without those users requesting such information. As further noted above, such a message might be dispatched, for instance, by action of a corresponding group manager, group member, and/or the like, perhaps with a particular goal in mind (e.g., increasing group membership).

It is noted that, according to various embodiments of the present invention, analogous messages could be sent out with respect to groups corresponding to game instances. Accordingly, for instance, such might be dispatched with respect to a particular group corresponding to a game instance by action of a group manager, group member, and/or the like that, for example, wished to draw other users to the corresponding game instance. The group manager, group member, and/or the like might act to have such a message sent, for example, via an interface provided by, for instance, one or more program modules employable for playing the game associated with the group.

It is further noted that such a group manager, group member, and/or the like might specify additional information relating to the sort of users sought. Such information could include, for instance, properties, traits, and/or the like. As a specific example, such information might specify that only users that had earned at least a specified score in a specified game and/or with respect to a specified game type were sought.

The message could be sent out in a manner analogous to that discussed above. Accordingly, for instance, the message might be sent out by way of email, MMS messaging, SMS messaging, OBEX OPP, sending a dispatch message via a network formed of nodes, and/or the like. Messaging via the network of nodes might be via peer-to-peer and perhaps, when available, direct links.

The message could, in various embodiments, be routed via nodes to those nodes belonging to the group. In various embodiments, inside each such node, the message could be routed via, for instance, one or more appropriate software modules. Such one or more appropriate software modules might, for instance, correspond to a group router handling game messages for the group. The one or more appropriate software modules could act to route the message to the node's own gaming application and/or to one or more other nodes that the node knew to belong to the group. It is noted that, in various embodiments, receipt of such a message at a node could, perhaps in accordance with the node's settings, activate one or more program modules employable for playing the game associated with the group. In various embodiments, the one or more modules employable for playing the game might act to decide wither or not the node's user should be notified of the message.

Group Creation Operations

According to various embodiments of the present invention, a user may request that a new group be created. With the request, the user might be able to ask to be a group manager for the new group. The user could make such a request, for instance, via a GUI or other interface provided by her node.

In response to the request, the user's node could, in various embodiments, query the user for metadata and/or other parameters corresponding to the group to be created. Included in the metadata could be, for instance, a group name and/or a group description. In various embodiments, the node could act to create a unique identifier or the like and associate it with the supplied metadata and/or other parameters. Creation of the unique identifier or the like could, for instance, be performed in a manner analogous to that discussed above.

Next, the node could, in various embodiments, query the user as to whether completion of a membership application would be required to attempt to join the new group. Where the user indicated that such an application would be required, the node could request that the user create the application. Accordingly the node could, for instance, present the user with a GUI or other interface whereby the user could indicate the questions to be asked of and/or information to be gathered from a group applicant. As alluded to above, among the information gatherable by such an application could be billing data. Such functionality might be employed, for example, in the provision of groups for which subscription was required.

As a next step, the node could, in various embodiments, query the user for group rules corresponding to the group to be created. Such functionality could be implemented in a number of ways. Among the group rule information sought by the node could, where a membership application was to be employed, be acceptable responses to questions asked by and/or information gathered by the membership application. Accordingly, the user could, via a GUI or other interface, provide the node with specified appropriate responses, ranges of appropriate responses, and/or the like.

Additional group rules sought by the node could be, for example, an expiration date for the group, a maximum number of members, and/or whether or not the group should be findable by searching operations. In various embodiments, the user may be able to specify preferred values for such, perhaps in accordance with ranges established, for instance, by a service provider, software, and/or the like. Further sought could be information regarding the services to be provided for the group, and perhaps specifics corresponding to the provision of those services. For instance, it might be possible for the user to specify which one or more of sharing, instant messaging, and chat services should be provided with respect to the group. Specifics that could be indicated by the user with respect to such services might include, for example, rules regarding sharable entities. In various embodiments, the node could query the user as to what users should be group managers for the group. The query could ask the user if she wished to be a group manager in the case where she had not already indicated such a desire.

Next, the node could send a message to a service provider node or the like containing the collected information regarding the group to be created. Further included in the message could be data corresponding to the user. The message could, for example, be sent via email, MMS messaging, SMS messaging, OBEX OPP, messaging via a network formed of nodes, and/or the like. Messaging via the network of nodes might be via peer-to-peer and perhaps, when available, direct links. After receiving the message, the service provider node or the like might act to determine if the user was entitled to create a new group. Accordingly, the service provider node or the like could, for instance, act to consult one or more appropriate rules. The rules might, for example, be provided by a system administrator and/or the like.

Next, the service provider node or the like might, in various embodiments, act to perform any necessary charging or billing operations regarding the user's request. Accordingly the service provider node or the like might act to bill the user for the creation of the group. Billing could be in accordance with one or more established rules, the rules perhaps provided by a system administrator or the like.

Where the service provider node or the like determined that the user was not entitled to create a group, and/or where billing operations produced an unsatisfactory result, the service provider node or the like could act to send a message to the user informing her of such. The message could be sent, for instance, via email, MMS messaging, SMS messaging, OBEX OPP, messaging via a network formed of nodes, and/or the like. Messaging via the network of nodes might be via peer-to-peer and perhaps, when available, direct links.

Next, after performing any necessary checks regarding the user's being permitted to create a group and any necessary billing operations, the service provider node could act to create the group. In various embodiments, the service provider's node could act to create a unique identifier or the like for the group, and associate it with the user-supplied metadata and/or other parameters. Creation of the unique identifier could, for instance, be performed in a manner analogous to that discussed above.

Accordingly, the service provider node or the like could, where the user requested to be a group manager for the new group, act to establish the user as such and to perform appropriate operations so that the user's node could act, in accordance with that discussed above, to respond to requests to join the new group. Included in such operations could be, for example, providing one or more appropriate certificates to the user's node. As one specific example, the certificate could be a group management certificate. Further, the service provider node or the like could perform appropriate operations so that one or more nodes could act as discussed above to present the new group as a joinable group.

Still further the service provider node or the like could, in various embodiments, act to allow for membership application functionality of the sort described above. Accordingly, the service provider node or the like could, for example, act to have a Java application or the like of the sort described above created and/or to have a secure server of the sort described above established. The service provider node or the like could do such in a number of ways. For example, the service provider node or the like could create the Java application or the like could using automatic code generation techniques known in the art. As another example, the service provider node or the like could act to communicate with a secure server or the like to have the above-described functionality implemented. Alternately, the service provider node or the like might act to inform one or more individuals of a need to have such tasks performed.

It is noted that, in various embodiments, service providers could act to control group creation. For instance, service providers could act to accept or reject group rules, and/or to preset the selection of acceptable and/or default values into an interface or the like employed by a user in defining group rules.

It is noted that various sorts of groups could be created in accordance with various embodiments of the present invention. For example, groups requiring a membership application to be completed might include groups created by families, businesses, or groups of friends. As another example, groups for which subscription was required might include groups created by service providers, content owners, software companies, and/or the like.

An expiration data could, in various embodiments, be set for a group. By appropriately choosing an expiration date, a group which could be thought of as a “temporary group” could be created. Such a temporary group could be employed for a number of purposes including, for example, gatherings and special occasions.

Additional examples of groups include, for instance, groups related to clubs, groups related to hobbies, business-to-business (B2B) groups and business-to-consumer groups (B2C).

It is further noted that, in various embodiments, operations allowing for the merging of groups could be performed. For example, system administrators, group managers, and/or others might be able to specify that one or more groups be merged to create a new group, the new group perhaps being specified to replace the one or more groups. In performance of the merging, various operations could be performed. For instance, operations could take place such that members of the one or more groups would be considered to be members of the new group. Further, group metadata might be combined, perhaps in accordance with semantic mappings and/or the like, and the merged group metadata could be updated to nodes of members of the new group. The mappings might, for instance, be provided by a system administrator, software, and/or the like. The group metadata in this context could, in various embodiments, mean both metadata describing the group, metadata listing members of the group, and/or the like, and/or group-specific metadata related to, for instance, media items and content.

Further, operations might take place so that downloadable entities and/or the like that were made available with respect to the one or more groups would be made available with respect to the new group. Such operations might, for instance, involve directory-level actions. It is noted that in various embodiments, for such a merging to take place, permission might need to be received from the managers associated with each of the one or more groups.

Additional Operations

According to various embodiments of the present invention, operation may be such that use of services, such as entity sharing and the other services described above, would not be anonymous. For example, as will be discussed in greater detail, a user might be required to present a certificate in order to make use of a service, wherein the certificate contains information identifying the user.

It is further noted that, in various embodiments, one or more identifiers could be associated with shared entities. Such an identifier might, for example, serve to identify the user that initially made the entity available for sharing. As another example, such an identifier might serve to identify a producer and/or owner of the content corresponding to the entity. As a specific example, for a music media file entity, such an identifier might indicate the copyright holder.

Such identifiers could, in various embodiments, be associated with a shared entity in such a way that it could not be easily changed by unauthorized users. For instance, the identifiers could be digitally signed. It is further noted that, in various embodiments, shared entities could be digitally signed and/or encrypted. Further, various embodiments could allow for the purchase of entities. Such functionality could, for instance, involve performance of associated billing operations such as interface with credit card and/or banking systems, perhaps via use of one or more techniques known in the art.

Moreover, in various embodiments of the present invention, an event log could be maintained regarding entities received by users. The event log could, for instance, be employed as a deterrent for illegal entity sharing and/or as a tool to track down users that performed illegal entity sharing. It is noted that, in various embodiments, groups and/or users could eliminated in the case of improper behavior, illegal activity, and/or the like.

Event log functionality could be implanted in a number of ways. For example, each node could be configured to maintain a log of the entities it received and the entities it provides to other nodes, and to periodically transmit the log to a central server or the like. The central server or the like could act to compile the received logs into one or more master logs.

In various embodiments of the present invention, a user could specify a node to act as a proxy for her node in performing various operations. The user could perform such specification, for example, via a GUI or other interface provided by her node. For example, a user could, according to various embodiments, be able to specify a proxy for her node with respect to receiving entities. Accordingly, a request for receipt of an item of the sort noted above could include an indication that the entity should be delivered to the proxy. For instance, included in the email, MMS message, SMS message, OBEX OPP transmission, messaging via a network formed of nodes, and/or the like could be a network address, a unique identifier with associated metadata, and/or the like sufficient for the entity to be directed towards the proxy node.

For certain embodiments, the user could be able to specify that all entities be delivered to the proxy. Alternately or additionally, the user could be able to specify rules according to which it would be decided wither an entity would be delivered to the user's node or to the corresponding proxy. As a specific example the user could be able to specify, perhaps via a GUI or other interface provided by her node, that only entities meeting certain specified size and/or type criteria be delivered to the proxy, and that all others be delivered to her node.

In an analogous manner, a user could, in various embodiments, be able to specify a proxy for her node with respect to providing entities to other nodes. Accordingly, a search reply message or other messages of the sort noted above regarding available entities might indicate that the proxy would perform the necessary operations. The indication, for example, might, as above be a network address, a unique identifier with associated metadata, and/or the like sufficient for the necessary operations to occur with respect to the proxy. In embodiments where such is appropriate, a proxy node specified for entity provision operations might also be employed in related search operations.

It is noted that in various embodiments a user might be able to, perhaps in a manner analogous to that discussed above with respect to receiving entities, specify rules relating to when the proxy should be employed. It is further noted that proxy functionality could be applicable under a number of circumstances. For instance, a user might employ such functionality in the case where her node lacked adequate processing power, energy resources, storage space, network connectivity, and/or the like to receive and or dispatch entities in a manner satisfactory to the user.

Additionally, it is noted that in various embodiments multiple service providers can arrange service interoperability for roaming users. For example, each such service providers could act to advertise each other's groups (e.g., public groups). As another example, such service providers could act to allow for interoperability of associated public keys. As still another example, such service providers could act to distribute each other's public keys. As an additional example, such service providers could act to agree upon the ports to be established for use in various operations discussed herein. Further, service providers can, in various embodiments, notify each other's users about certificate management related statuses (e.g., by providing certificate blacklists identifying users that have acted improperly and/or nodes corresponding to those users).

Certificates and Fees

As noted above, various embodiments of the present invention employ certificates. For example, as noted above a certificate corresponding to a group could be given to a user upon her becoming a member of that group. As another example, as noted a general access certificate could be given to a user. As yet another example, in various embodiments it could be required that for dispatch of messages of the sort noted above with respect to a particular group, a certificate proving membership in that group be presented.

As alluded to above, certain message dispatches could, in various embodiments, be performed without relation to a particular group. For instance, in certain embodiments message dispatches corresponding to joining a group could be performed without respect to a particular group. Accordingly, in various such embodiments it could be required, for example, that the above-noted general access certificate be shown for such message dispatches.

Various requirements could be implemented regarding the way in which certificates needed to be shown. For example, in certain embodiments it could be required that an appropriate certificate be shown for each message dispatch. As another example, requirements might be such that the appropriate certificate need only be shown when establishing a connection or the like, and that multiple messages could be dispatched over a connection or the like so established without it being required that the certificate be shown for each message dispatch. This type of connection between nodes might, for example, further be used for transporting messages that are related to the groups in common between the nodes. This type of connection could thus serve connectivity between more than one common group and, in various embodiments, if the settings of the nodes so allow, it could also enable by-passing of generated traffic described herein not limited to common groups. As a specific example, a connection between two peer nodes verified with generic access certificates and/or specific group membership certificates. and secret and public keys corresponding to the nodes could be used to transport in a multiplexed way traffic of specific groups.

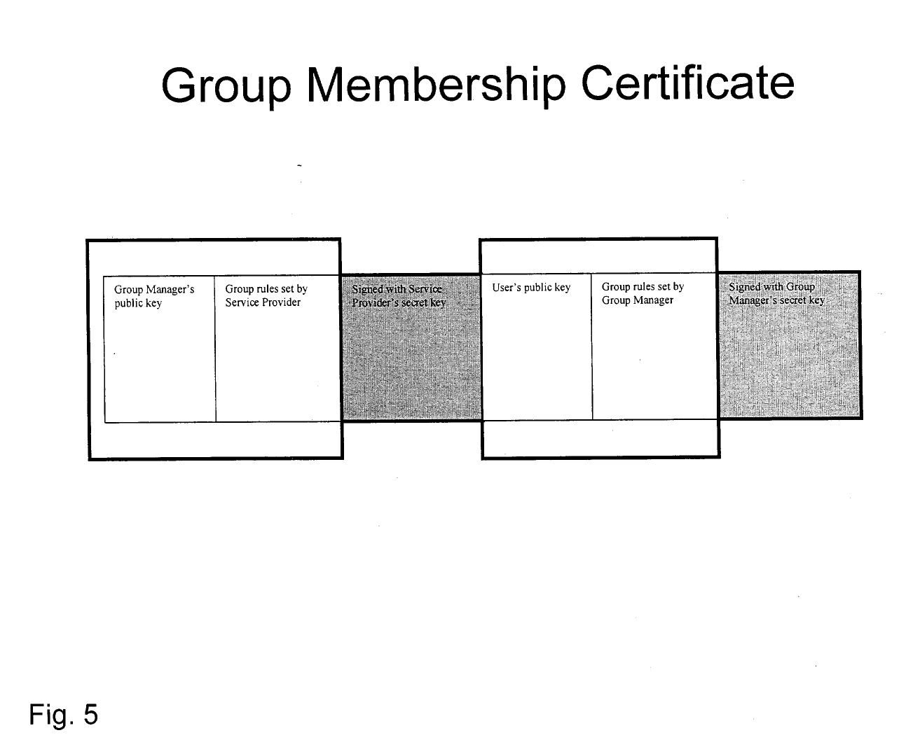

A certificate corresponding to a particular group could, for example, include sections signed with a secret key possessed by a service provider and/or the like, and/or could include sections digitally signed with a secret key possessed by a group manager associated with the group. Shown in FIG. 5 is an exemplary group membership certificate wherein a section containing a group manger's public key and group rules set by a service provider is signed with the service provider's secret key, while a section containing a public key of a user to which the certificate is given and group rules set by the group manager is signed by the group manager's secret key.

It is noted that a certificate could contain information corresponding to the identity of a user an/or could serve as evidence of the identity of a user. In various embodiments, such certificates could be employed so that users would not be anonymous in one or more of their actions. It is further noted that secret keys and/or public keys could be created, for example, via various techniques known in the art.

It is further noted that the above-described functionality wherein a certificate is shown could be implemented, for instance, using various authentication, certificate challenge and/or verification techniques. Certificates, secret keys, and public keys are thus, in various embodiments, used together to prove identity and membership in a group.

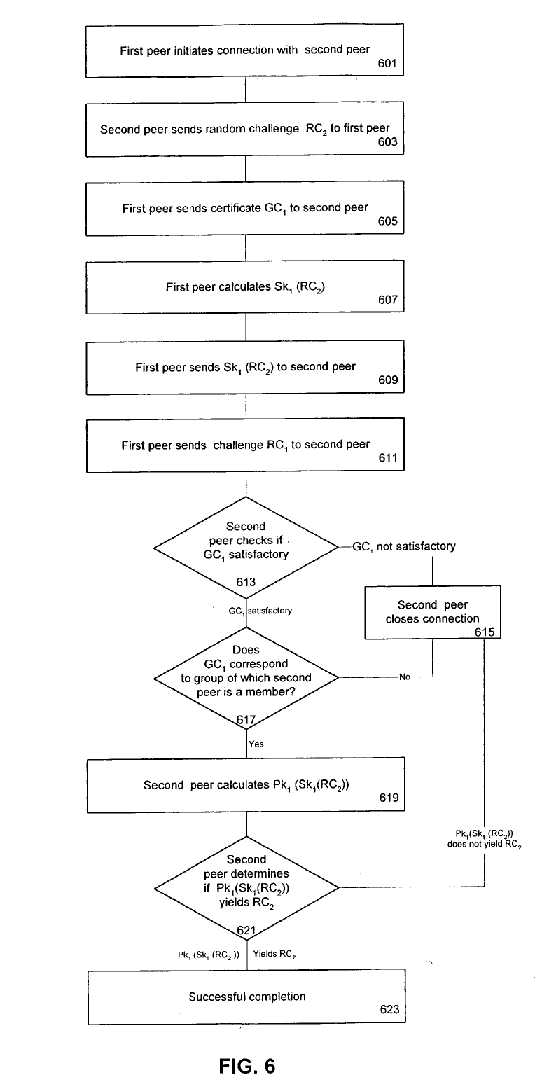

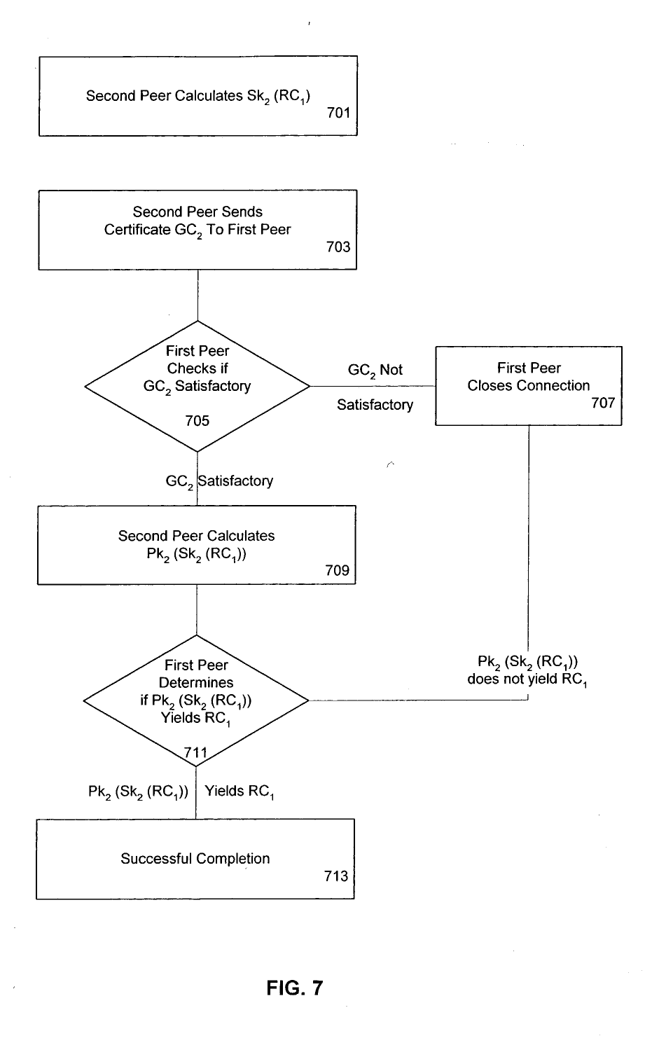

Shown in FIG. 6 is an exemplary authentication procedure employable in various embodiments of the present invention wherein a second peer node acts to authenticate a first peer node, and shown in FIG. 7 is an exemplary authentication procedure employable in various embodiments of the present invention wherein the first peer acts to authenticate the second peer. An authentication procedure such as that shown in FIG. 7 could, for instance, take place after an authentication procedure such as that shown in FIG. 6 has successfully completed.

Turning to the exemplary authentication procedure of FIG. 6, the first peer first initiates a connection with the second peer (step 601). Next, the second peer sends a random challenge RC₂ to the first peer (step 603). In response, the first peer sends an appropriate group membership certificate GC₁ to the second peer (step 605). Next, the first peer uses its secret key Sk₁ to encrypt the challenge RC₂ sent by the second peer (i.e., the first peer calculates Sk₁(RC₂) (step 607). Next, The first peer sends the encrypted challenge Sk₁(RC₂) to the second peer (step 609). Next, the first peer sends a challenge RC₁ to the second peer (step 611). As a next step, the second peer checks the group membership certificate GC₁ received from the first peer (step 613). In the case where the check finds GC₁ to be unsatisfactory, the second peer acts to close the connection (step 615). In the case where the check finds GC₁ to be satisfactory, a determination is made as to whether or not GC₁ corresponds to a group of which the second peer is also a member (step 617). From one point of view, this might be thought of as a determination of whether or not the first peer and the second peer both belong to the group to which GC₁ corresponds. In the case where the determination yields a negative result, the second peer acts to close the connection (step 615). In the case where the determination yields a positive result, the second peer acts to decrypt the encrypted challenge with the first peer's public key (i.e., the second peer calculates Pk₁(Sk₁(RC₂)) (step 619). Next, the second peer determines if the calculation of Pk₁(Sk₁(RC₂)) properly yielded the challenge RC₂ that it sent to the first peer (step 621). In the case where the determination yields a negative result, the second peer acts to close the connection (step 615). In the case where the determination yields a positive result, the procedure of FIG. 6 is considered to have completed successfully (step 623).

As noted above, the authentication procedure such as that shown in FIG. 7 may take place after successful completion of an authentication procedure such as that shown in FIG. 6. Turning now to FIG. 7, the second peer uses its secret key Sk₂ to encrypt the challenge RC₁ sent by the first peer (i.e., the second peer calculates Sk₂(RC₁) (step 701). Next, the second peer sends its group membership certificate GC₂, corresponding to the same group to which GC₁ corresponds, to the first peer (step 703). Next, the first peer checks the group membership certificate GC₂ received from the second peer (step 705). In the case where the check finds GC₂ to be unsatisfactory, the first peer acts to close the connection (step 707). In the case where the check finds GC₂ to be satisfactory, the first peer acts to decrypt the encrypted challenge with the second peer's public key (i.e., the first peer calculates Pk₂(Sk₂(RC₁)) (step 709). Next, the first peer determines if the calculation of Pk₂(Sk₂(RC₁)) properly yielded the challenge RC₁ that it sent to the second peer (step 711). In the case where the determination yields a negative result, the first peer acts to close the connection (step 707). In the case where the determination yields a positive result, the procedure of FIG. 7 is considered to have completed successfully (step 713).

Performing calculations of the sort noted above can, in various embodiments, prove energy, processor, and/or resource intensive for a node. With regard to the exemplary authentication procedures of FIGS. 6 and 7, it is noted that the second peer does not perform any calculations (e.g., the calculation of step 619) until it is determined that GC₁ is satisfactory and corresponds to a group of which the second peer is also a member. It is further noted that the second peer can break the connection if those determinations do not yield positive results. On the other hand, the first peer must perform calculations early on (e.g., the calculation of step 607). Such behavior might be beneficial, for instance, in the case where the first peer is a hostile peer, as the second peer would not need to perform the calculations while the first, hostile peer would.

With further regard to the exemplary authentication procedures of FIGS. 6 and 7, it is noted that the challenges allow each node to confirm that the other is the node indicated by the provided certificate.

It is further noted that, in various embodiments, there may be several authentication levels. As an example, a general public group might not require as high security as a private group. Accordingly, in various embodiments, different authentication levels may be provided for different groups. For instance, a highest authentication level might involve exchange of group membership certificates, secret key and public key exchange, the and use of an PIN (Personal Identification Number), secret code, and/or the like. As an additional security step, the PIN, secret code, and/or the like might, perhaps, be communicated only in the case of a direct link between the nodes establishing communications.

It is noted that, in various embodiments, certificate chaining might be performed. For example, a group manager could provide chained group management certificates to delegate group managers or the like that entitled those delegate group members to grant group membership certificates to other users. In certain embodiments, all members of a group could posses such chained group management certificates, and thus all members could be entitled to grant new membership certificates. In certain embodiments, entitlement to grant new membership could be subject to one or more limitations. The limitations might, for instance, be set by the group manager providing the chained group management certificates.

Such limitations might, as a specific example, stipulate that individuals possessing the chained certificate could only grant membership to others in the case where the group manager was not reachable. In such an embodiment, a user might request from a group manager and/or service provider the chained certificate for later use, for example, in the case where the group manager came to be not reachable. Alternately or additionally, such a chained certificate might be provided to the user and/or her node by a group manager and/or service provider for later use should the group manager come to be not reachable.

It is noted that, in embodiments where there are multiple service providers, there may be a need to distribute the public keys of all relevant service providers to user nodes. Such might occur, for example, by distribution via a general group.

According to various embodiments of the present invention, fees could be charged with respect to various operations. For example, fees could be charged for operations such as joining groups, creating groups, joining chat boards, creating chat boards, sending instant messages, receiving instant messages, making entities available for receipt, and/or receiving entities. Alternately or additionally, fees could be charged, for example, for a user's receipt of above-described modules, group certificates, and/or the above-described general access certificate.

For example, a service provider might collect fees for granting group manager rights with a group manager certificate. The size of the fee could depend, for instance, on group rules described in certificate (e.g., operations allowed in group (e.g., sharing and/or chat), visibility (e.g., public or private) of a group, amount of members, etc). In various embodiments, a service provider might be able to set and/or control the limits of how many groups a user can be a member of simultaneously. It is noted that, in certain embodiments, software modules on a user's node might need to be upgraded in order to enhance the number of possible groups. Such might, for instance, be bundled to a service provider service package, or be a separate transaction. Group manager software modules might, in various embodiments, act to collect information of actions like joining and resigning a groups, and execute charging on its own and/or via a service provider (e.g., by transmitting charging events to service provider).

Metadata

Various embodiments of the present invention described herein have been discussed as employing metadata. Various aspects of, for example, metadata will now be discussed.

In various embodiments, there may be one or more defined sets and/or schemas of acceptable metadata values, fields, and/or the like. Further, in various embodiments a user may enter metadata for various purposes (e.g., search). Such entry might, for instance, be via appropriate GUI elements and/or the like. Accordingly, for example, a user might be able to enter metadata corresponding to defined sets and/or schemas (e.g., subject, title, format, creator, member name, and/or the like).

It is further noted that, in various embodiments, a user may be able to enter freely written text based keywords, other types of information (e.g., audio), and/or the like. Such entry might, for instance, involve appropriate GUI elements. In various operations (e.g., search), such freely written text based keywords, other types of information, and/or the like could, for instance, be considered in light of one or more defined sets and/or schemas of acceptable metadata values, fields, and/or the like.

In various embodiments, operations could be performed to associate freely written text based keywords, other types of information, and/or the like could with appropriate metadata values, fields, and/or the like from the sets and/or schemas. Such appropriate metadata values, fields, and/or the like from the sets and/or schemas could, for instance, be ones determined to correlate best with the freely written text based keywords, other types of information, and/or the like. Such determination of associations could, for instance, take into account metadata analysis, text analysis, mapping of keywords against most likely metadata values fields, and/or the like. It is noted that in various embodiments it might be preferred and/or suggested that a user enter metadata corresponding to one or more defined sets and/or schemas of acceptable metadata values, fields, and/or for operations such as, for instance, search.

Once a user has provided criteria (e.g., search criteria) as metadata, and/or freely written text based keywords, other types of information, and/or the like, the user's node might, for instance, act to dispatch an appropriate message or the like (e.g., a query message or the like). It is noted that, in various embodiments, the user's node might add parameters to the query or the like describing, for instance, the node's capabilities relating to handling of various content formats. It is further noted that, in various embodiments, the user's node may act to associate freely written text based keywords, other types of information, and/or the like with appropriate metadata values, fields, and/or the like from the sets and/or schemas. Accordingly, the node could include in the message or the like metadata and/or other data relating to the associations. Alternately or additionally, the user's node might include in the appropriate message or the like entered freely written text based keywords, other types of information, and/or the, and the recipient node could act to perform such association.

Moreover, in various embodiments a group may have it's own defined practices and/or group-specific metadata sets and/or schemas. Such might, for instance, be defined by a group manager, a member, and/or a member with a specific role in a group. In certain embodiments, a group-specific metadata set and/or schema could be a subset of a set and/or schema, for instance, made available to all groups and/or by a system administrator, service provider, and/or the like. For example, a group might have a set and/or schema relating to music sharing that is a subset of a file sharing set and/or schema made available to all groups and/or the like, the music sharing set and/or schema containing only metadata values, fields, and/or the like appropriate for music sharing.

As another example, a group-specific metadata set and/or schema might be an extension of a set and/or schema made available, for example, to all groups and/or the like. Such a group-specific metadata set and/or schema might, for instance, contain added metadata values, fields, and/or the like relating to particulars of the group. As specific examples, a group corresponding to music might add metadata values, fields, and/or the like relating to music genres, a group corresponding to photography might add metadata values, fields, and/or the like relating to photographic quality information and/or camera settings, and a group corresponding to amateur radio might add metadata values, fields, and/or the like relating to DX radio codes. In various embodiments, group-specific metadata sets and/or schemas could be distributed, updated and/or maintained, perhaps by exchanging updates between nodes belonging to the corresponding group. In various embodiments, a node might receive the latest version of a corresponding group-specific set and/or schema when joining a group. Further, in various embodiments, a node associated with a group might act to receive, perhaps via the action of one or more appropriate software modules, updates to group-specific sets and/or schemas corresponding to joined groups. Such might, for instance, occur periodically.

User Interface

As noted above, various embodiments of the present invention may employ a GUI (Graphical User Interface) for various purposes. Exemplary GUI functionality regarding a user node will now be discussed. It is noted that in various embodiments of the present invention, alternate GUI functionality might be employed. Accordingly, various embodiments could employ some or none of the exemplary screens presented below.

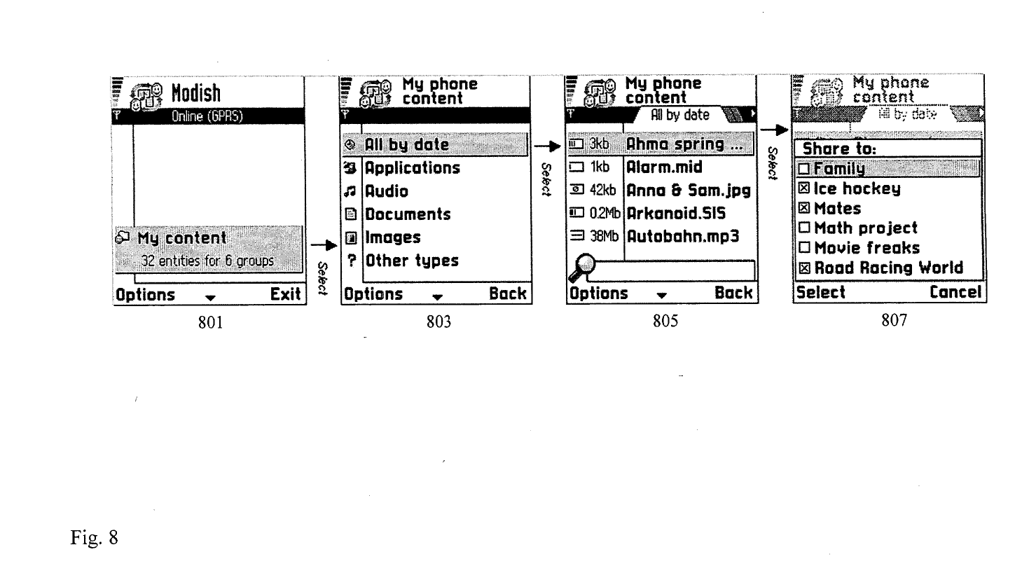

Shown in FIG. 8 are various exemplary GUI screens relating to a user viewing entities that she has made available for receipt by other nodes. In screen 801, it is indicated that the user is making 32 entities available with respect to six groups to which she belongs. By selecting the item in screen 801, the user could be presented with screen 803 wherein she could select an entity type. In the case where the user selected the entity type “All by date”, she could be presented with various entities and folders of entities that she had made available with respect to the groups to which she belongs (screen 805). Screen 805 could allow the user to select a displayed folder made available to view the corresponding entities contained therein. The entities displayed in screen 805 have corresponding graphical indicators showing sharing status (e.g., blocked, not shared, or shared for certain groups). In this example, selecting the folder “Ahma_spring . . . ” in screen 805 could result in the user being presented with screen 807 indicating the groups in which the entity is being made available.

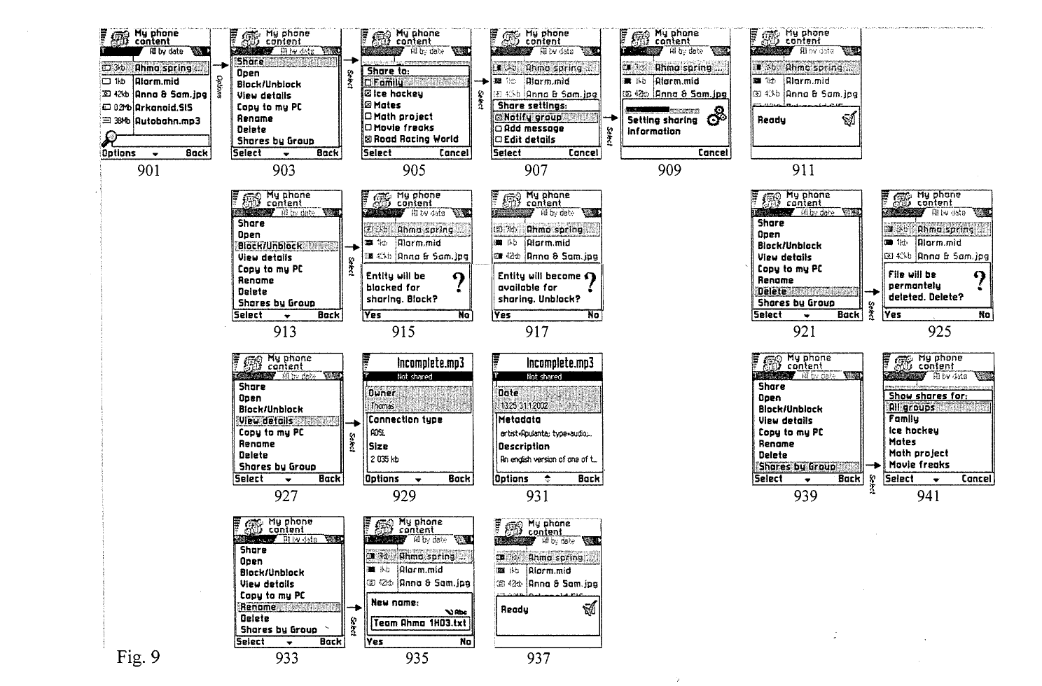

Shown in FIG. 9 are various exemplary GUI screens relating to various operations performable by a user with respect to entities. In connection with screen 901 the user may select entities, and via screen 903 the user can indicate a desire to share the selected entities. In screen 905, the user is queried as to the groups with respect to which the selected entities should be made available, and in screen 907, the user can indicate additional settings for sharing. In screen 909, the user is presented with an indication that appropriate operations are being performed in response to the user's indications. In screen 911, the user is informed that the operations have successfully completed.

Screen 913 allows the user to block or unblock sharing of a file. Screen 915 presents a query in the case where a user specifies to forbid sharing of an entity. The user selecting the unblock option results in her being presented with screen 917. Upon the user affirmatively answering to the question posed in screen 917, sharing of the entity is enabled.

In screen 921, the user is allowed to indicate a desire to delete an entity. In screen 925 the user is asked to confirm the deletion request. Where the user indicated in screen 925 that deletion should proceed, the node could perform the deletion.

Screen 927 allows the user to indicate a desire to view details associated with a particular entity. In screens 929 and 931, the user is presented with a listing that displays the details associated with the entity. Screen 933 allows the user to indicate a desire to rename an entity, and in screen 935 the user is prompted for entering a new name for the entity. After entering the new name, a confirmation is displayed to the user as illustrated in screen 937. Screen 939 allows the user to indicate a desire to view entities that are being shared only to a certain group. Screen 941 presents a listing in which the use can select an appropriate group.

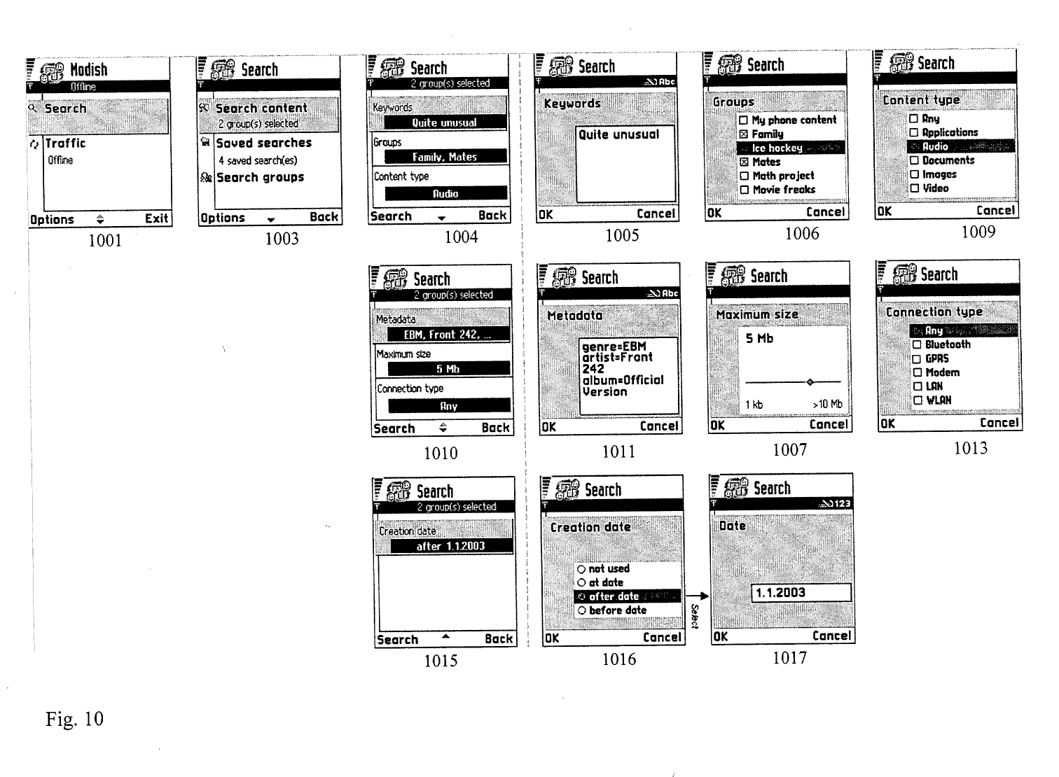

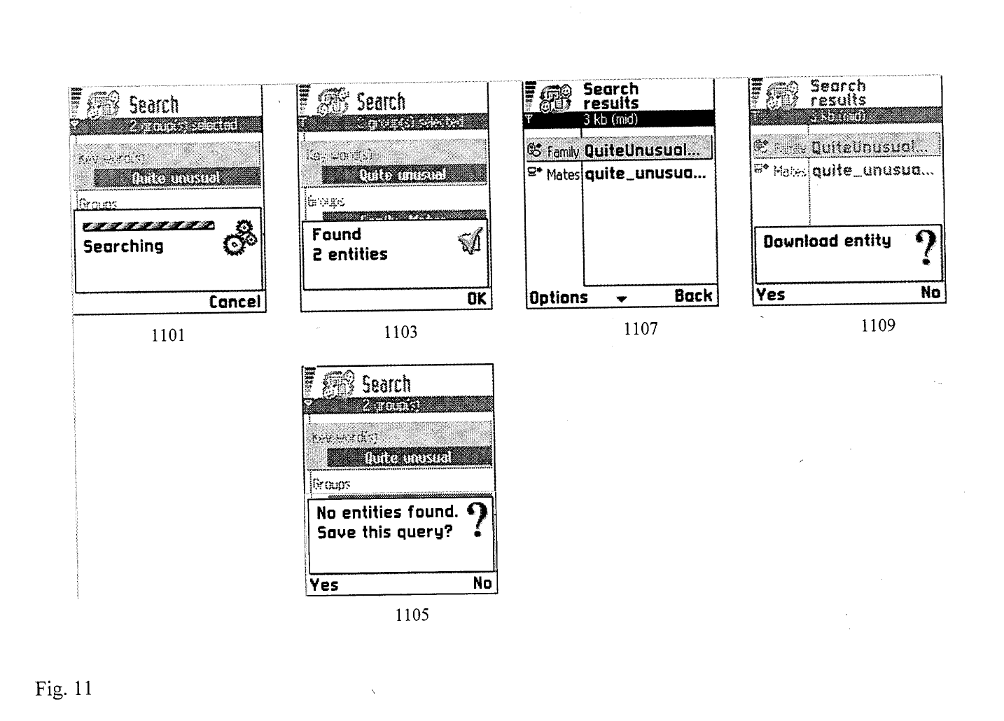

Shown in FIGS. 10 and 11 are various exemplary GUI screens relating to entity search operations performable by a node's user. Via screen 1001 of FIG. 10, the user is able to indicate a desire to search for entities. In screen 1003, the user is prompted as to the sort of entity for which she wishes to search. Screens 1004, 1010, and 1015 present listings of search attributes selectable by the user. Via screen 1005, the user is able to indicate keywords corresponding to metadata relating to the entities for which she wishes to search. In screen 806, the user may select from which groups the search is being made. Via screen 1006, the user may additionally specify that search be made with respect to her own node. In screen 1007, the user is able to specify size metadata relating to the entities for which she wishes to search. In screen 1009, the user is able to specify media type metadata relating to the entities for which she wishes to search. In screen 1011, the user is able to specify additional metadata relating to the entities for which she wishes to search. In screen 1013 the user is able to specify one or more network interfaces to be employed in searching for and/or receiving entities. Via screens 1016 and 1017, the user is able to indicate a time and date at which searching should commence.

In screen 1101 of FIG. 11, the user is provided with indication that searching is being performed. In the case where searching yields found entities, the user is presented with screen 1103 where the user is notified that searching has completed and told how many entities have been found. Via screen 1107, the user is presented with the found entities and given the opportunity to select one or more for receipt. The entities displayed in screen 1107 have corresponding graphical indicators imparting bandwidth and connection information. In the case where the user selects one or more files for receipt, she is presented with screen 1109 where she is asked to confirm this desire. In the case where searching yielded no found entities, the user is presented with screen 1105 where the user is notified that searching has completed but that no entities had been found and presented with an option to save the query for later use.

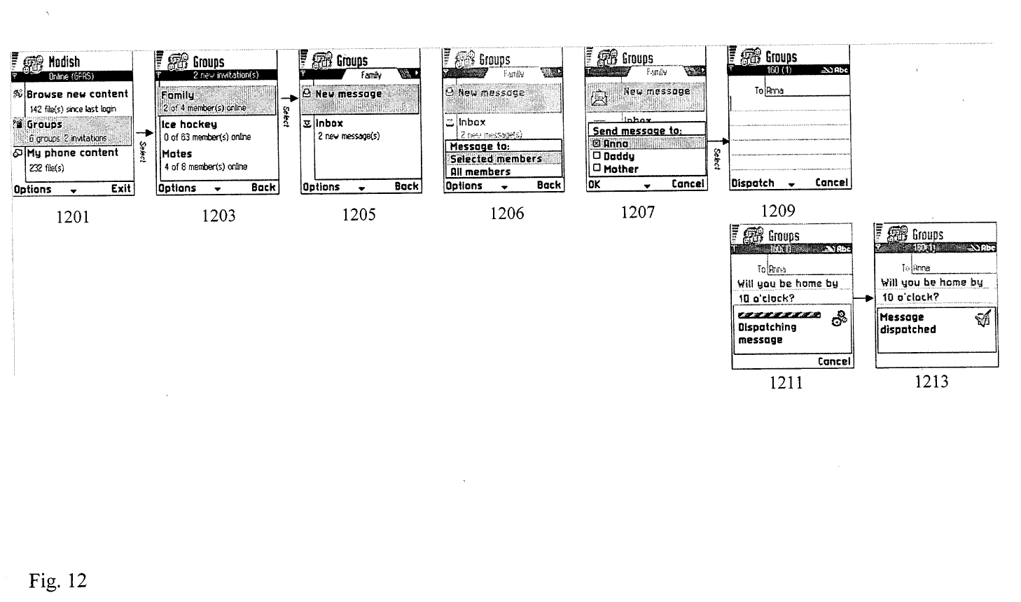

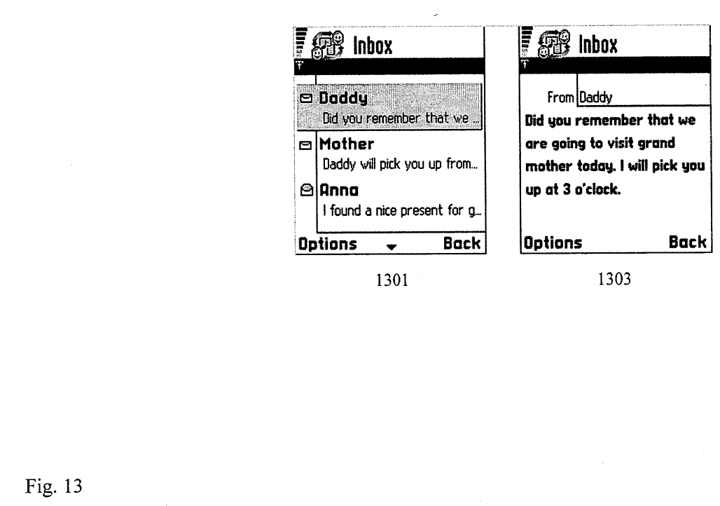

Shown in FIGS. 12 and 13 are various exemplary GUI screens relating to instant messaging operations performable by a node's user. Via screen 1201 the user is able to indicate a desire to perform instant messaging operations. In screen 1203 the user is presented groups of which she is a member and is prompted to select one or more groups with respect to which the instant messaging operations should be performed.

In screen 1205, the user is presented with various instant messaging operations and is prompted to choose one. Among the operations offered are one in which a new message is created and dispatched and one is which received messages can be viewed. In the case where the user selects the operation relating to creating and dispatching a new message, she is presented with screen 1206 where she can indicate a desire to send the message to the entire group or to selected members only. If the selected members option is chosen by the user, screen 1207 is displayed where the user is presented with one or more potential recipients and prompted to choose one or more of them as recipients of the new message. It is noted that, in various embodiments, the user might instead act to search for potential recipients.

Via screen 1209, the user is able to compose the message and to indicate a desire to dispatch the message. Where the user selects to dispatch the message, she is presented with screen 1211 indicating that dispatch is occurring and screen 1213 indicating that dispatch has completed. In the case where the user, via screen 1205, selected the operation relating to viewing messages, she could be presented with screen 1301 in which she is informed of viewable messages and prompted to choose one for viewing. Upon so selecting a message, it could be presented to her via screen 1303.

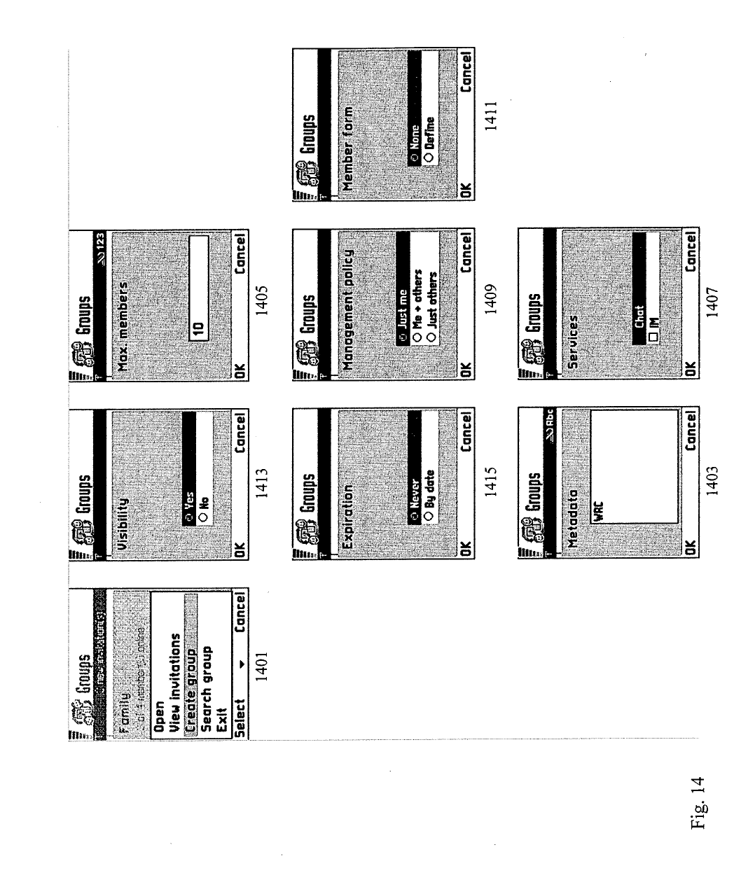

Shown in FIG. 14 are various exemplary GUI screens relating to group creation. Via screen 1401, a user could indicate a desire to create a new group. Via screen 1403, the user is able to specify metadata corresponding to the new group. Via screen 1405, the user is able to specify a maximum number of members for the new group. Via screen 1407, the user is able to select services that should be provided with respect to the new group. For example, in screen 1407, chat board (“Chat”) and instant messaging (“IM”) services are offered for selection.

Via screen 1409, the user is able to specify information regarding group managers for the new group. In screen 1409, the user is offered with the choices of only her being a group manager, her and specified others being group managers, and only specified others being group managers. Where appropriate, the user could next be presented with a GUI screen where the others to be group mangers could be specified.

Via screen 1411, the user is able to specify whether or not a user wishing to join the new group would need to fill out a membership application form. In the case where the user indicated that such an application form would be required, she could be presented with a screen allowing her to define the application form. In defining the application form, the user might be able to choose from and/or modify existing membership application forms. Via screen 1413 the user could indicate whether or not the new group should be findable by searching operations. Via screen 1415, the user could indicate an expiration date corresponding to the new group.

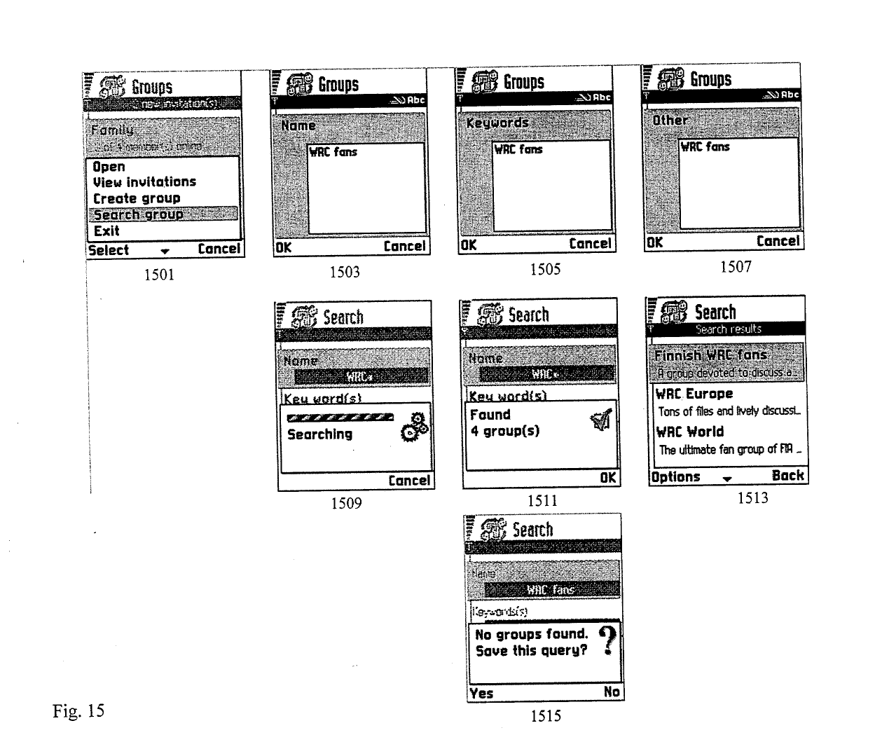

Shown in FIG. 15 are various exemplary GUI screens relating to searching for groups. Via screen 1501, a user could indicate a desire to search for a group. In screen 1503, the user is able to specify name metadata relating to the groups for which she wishes to search. In screen 1505, the user is able to specify keywords corresponding to metadata relating to the entities for which she wishes to search. In screen 1507, the user is able to specify additional metadata relating to the entities for which she wishes to search.

In screen 1509, the user is provided with indication that searching is being performed. In the case where searching yields found groups, the user is presented with screen 1511 where the user is notified that searching has completed and told how many groups have been found. Via screen 1513, the user is presented with the found groups and given the opportunity to select one or more as groups she wished to join. Screen 1515 is shown in the case where no group matching the search criteria have been found, and the user is queried as to whether she wants to save the query for later use.

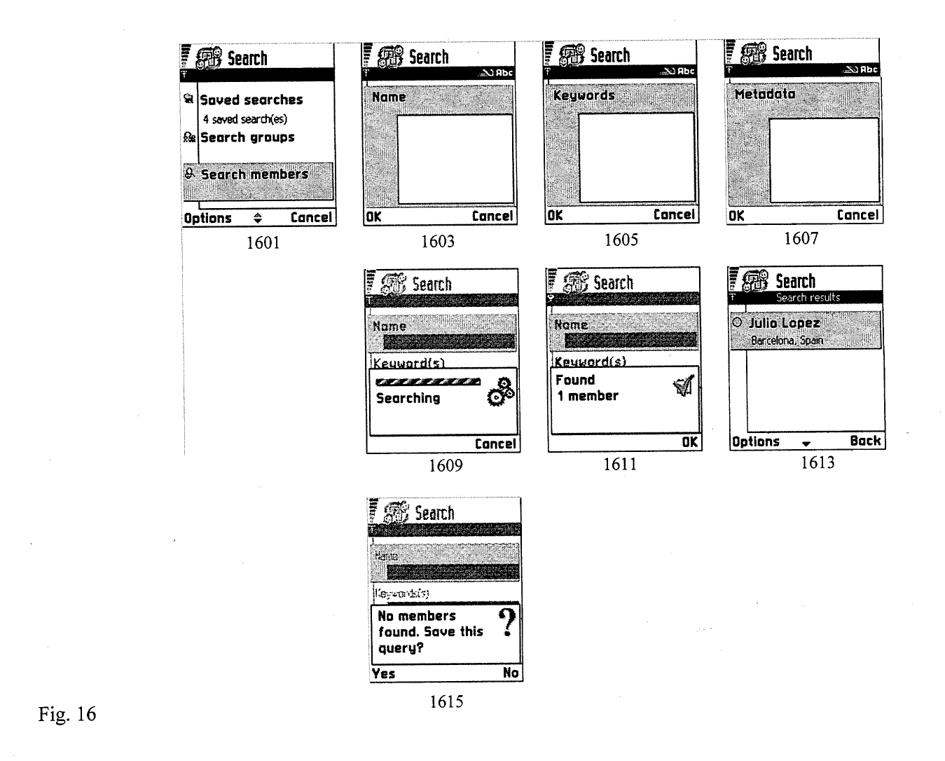

Shown in FIG. 16 are various exemplary GUI screens relating to searching for users and/or corresponding nodes. Via screen 1601, a user could indicate a desire to search for users and/or corresponding nodes. In screen 1603, the user is able to specify name metadata relating to the users and/or corresponding nodes for which she wishes to search. In screen 1605, the user is able to specify keywords corresponding to metadata relating to the users and/or corresponding nodes for which she wishes to search. In screen 1607, the user is able to specify additional metadata relating to the users and/or corresponding nodes for which she wishes to search.

In screen 1609, the user is provided with indication that searching is being performed. In the case where searching yields found users and/or corresponding nodes, the user is presented with screen 1611 where the user is notified that searching has completed and told how many users and/or corresponding nodes have been found. In the case that no members have been found, the user is prompted with an option to save the query for later use in screen 1615.

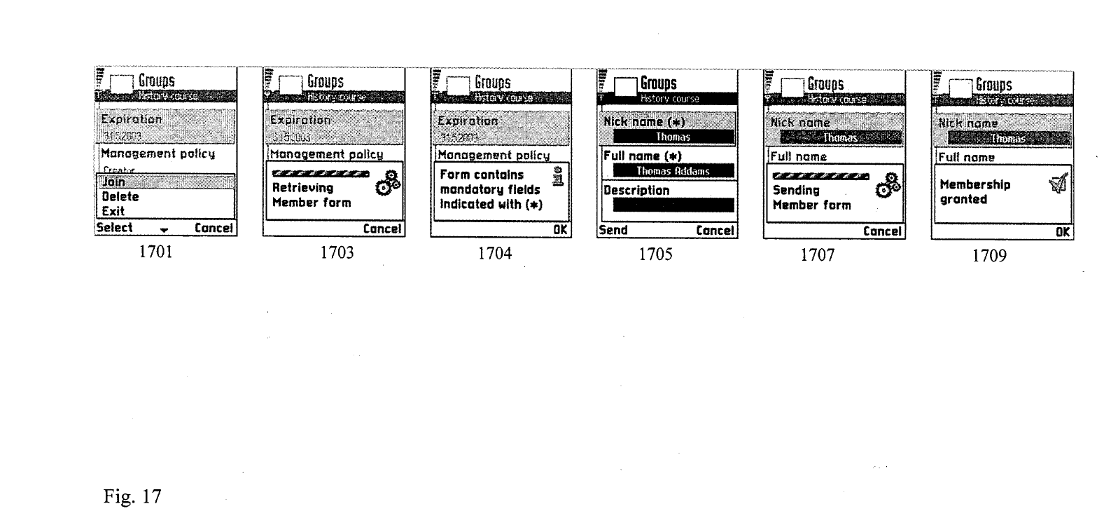

Shown in FIG. 17 is exemplary GUI screen 1701 whereby a user is able to indicate a desire to join a particular group. The particular group could, for instance, be one found via search operations of the sort noted above or through receiving and invitation. After the user has made such an indication, she could be presented with exemplary GUI screen 1703 informing her that a corresponding application form was being retrieved. In exemplary screen 1704, the user is notified that the application form contains mandatory fields that must be filled. In exemplary GUI screen 1705, the user could be presented with the retrieved form for completion. After completing the form, the user could employ screen 1705 to have the completed form appropriately submitted. In response, the user could be presented with exemplary screen 1707 indicating that the form was being submitted. Where the user was granted membership, she could be presented with exemplary screen 1709.

With further regard to user interfaces it is noted that, in various embodiments, a user need not need to wait for operations, results, and/or the like requested via a user interface to complete, be presented, and/or the like before doing something else with her node. Accordingly, for instance, the user could act to perform other operations described herein (e.g., by moving to another part of software providing such operations), to move to another application running on her node, and/or the like while waiting for requested operations to complete and/or requested results to be presented. Additionally, the user could, in various embodiments, receive non-intrusive notifications and status updates of the completion and/or progress of active operations.

Further, as noted above, in various embodiments, a user could be informed via a user interface of the costs she would incur and/or bandwidths she would enjoy in performing a particular network operation. For example, as noted above, where multiple hops were involved in a particular network operation, the user could be presented with a total cost and/or average bandwidth. As another example, as noted above, where multiple alternatives are available for performing a network operation, the user could be presented with cost and/or bandwidth information for each alternative.

Additionally, it is noted that, according to various embodiments, user interfaces described herein might be accessed by a node user, for example, via a joystick or the like (e.g., a 5-way joystick), a touch screen, and/or a keypad provided by that node. Further, it is noted that, according to various embodiments of the present invention, user interfaces may be implemented so as to allow for access of group-based downloadable entities (e.g., content such as media, files, games, etc.). Moreover, in various embodiments, user interfaces may be implemented such that operations with respect downloadable entities take place with respect to groups. Additionally, in various embodiments, user interfaces may be implemented such that a user is not allowed to mix downloadable entities (e.g., content) between groups.

According to various embodiments of the present invention, a node user may be presented with a GUI main menu providing a list of available operations. Included in the list could be, for instance, “Browse Newest Content”, “Access Local Content”, “Groups”, and/or “Application-Wide Functions”.

A user selecting “Browse Newest Content” could, for instance, be able to access and/or browse a downloadable entities inbox or the like whereby the user could, for example, browse recently-received downloadable entities. According to various embodiments, implementation of downloadable entities inbox functionality may be such that the inbox holds and/or links to all downloadable entities received since a certain date and/or point in time (e.g., since last logout). For such embodiments, browsing the inbox might be viewed as receiving results of an automatic search for downloadable entities received such that certain date and/or point in time. In various embodiments, a user browsing the inbox may be presented with indications of received downloadable entities, the indications divided into categories based on group, content type, and/or the like. Moreover, in various embodiments, graphical symbols or the like may be presented in conjunction with the indications of received downloadable entities. The graphical symbols or the like might, for instance, correspond to indications of transport carrier, cost, and/or the like.

A user selecting “Access Local Content” could, in various embodiments, be able to view all downloadable entities (e.g., content) held in her node and/or indicate which downloadable entities should be shared, and for which groups they should be shared. Moreover, in various embodiments the user could be able to act to explicitly block the sharing of particular entities. Accordingly, for example, GUI display to the user could be such that the user is presented with a list of downloadable entities, and for each one a graphical symbol or the like indicating a sharing state as blocked, not shared, or shared with respect to one or more, perhaps indicated, groups.

A user selecting “Groups” could, according to various embodiments, be able to perform a number of operations. For example, the user could be able to perform group management operations such as, for instance, operations corresponding to invitations such as inviting members to a group and/or joining a group via a received invitation. As another example, available to the user could be operations relating to group creation such as, for instance, the ability to access templates for group application forms. As yet another example, available to the user could be operations relating to joining a group such as, for instance, automatic pre-fill of personal information in group applications based on information presented by the user, for instance, as discussed below. As a further example, available to the user could be operations relating to browsing the inbox discussed above, but with respect to a particular group, operations relating to searching for downloadable entities within a group, and/or access to local content in a manner like that discussed above, but with respect to a particular group. As an additional example, available to the user could be operations relating to searching and/or accessing group members, accessing information relating to group members, and/or operations relating to accessing group features such as chat, messaging, and games. It is noted that, in various embodiments, the user could be required to select a single group before performing any group-related action.

A user selecting “Application-Wide Functions” could, according to various embodiments, be able to perform a number of operations. For example, the user could be able to perform operations with respect to ongoing download (e.g., view progress, pause, cancel, and/or delete), and/or perform operations with respect to ongoing uploads (e.g., view progress, pause, cancel, and/or delete). As another example, the user could be able to perform searches (e.g., using metadata and/or keywords) for downloadable content, perform searches (e.g., using metadata and/or keywords) for group members, perform searches (e.g., using metadata and/or keywords) for groups (e.g., public groups), and/or set corresponding settings. As yet another example, the user could be able to save search queries for later use, and/or set personal information employable, for instance, in the automatic pre-fill discussed above.

Hardware and Software

Certain operations and the like described herein may be executed by and/or with the help of computers. Further, the nodes described herein may be and/or may incorporate computers. The phrases “computer”, “general purpose computer”, and the like, as used herein, refer but are not limited to a processor card smart card, a media device, a personal computer, an engineering workstation, a PC, a Macintosh, a PDA, a computerized watch, a wired or wireless terminal, a server, a network access point, a network multicast point, or the like, perhaps running an operating system such as OS X, Linux, Darwin, Windows CE, Windows XP, Windows Server 2003, Palm OS, Symbian OS, or the like, perhaps employing the Series 60 Platform, and perhaps having support for Java and/or .Net.

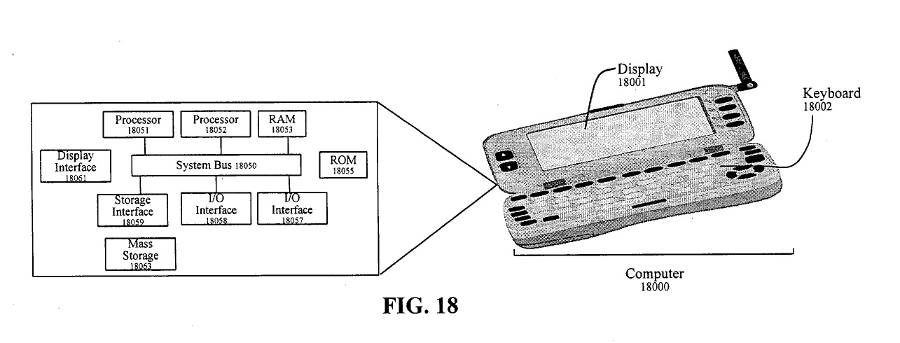

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 18000 as shown in FIG. 18 includes system bus 18050 which operatively connects two processors 18051 and 18052, random access memory 18053, read-only memory 18055, input output (I/O) interfaces 18057 and 18058, storage interface 18059, and display interface 18061. Storage interface 18059 in turn connects to mass storage 18063. Each of I/O interfaces 18057 and 18058 may be an Ethernet, IEEE 1394, IEEE 1394b, IEEE 802.11a, IEEE 802.11b, IEEE 802.111g, IEEE 802.16a, IEEE 802.20, Bluetooth, terrestrial digital video broadcast (DVB-T), satellite digital video broadcast (DVB-S), digital audio broadcast (DAB), general packet radio service (GPRS), Universal Mobile Telecommunications Service (UMTS), DVB-X, IRDA (Infrared Data Association), or other interface known in the art.

Mass storage 18063 may be a hard drive, optical drive, or the like. Processors 18057 and 18058 may each be a commonly known processor such as an IBM or Motorola PowerPC, an AMD Athlon, an AMD Opteron, an Intel ARM, an Intel XScale, a Transmeta Crusoe, an Intel Xenon, or an Intel Pentium. Computer 18000 as shown in this example also includes a touch screen 18001 and a keyboard 18002. In various embodiments, a mouse, keypad, and/or interface might alternately or additionally be employed. Computer 18000 may additionally include or be attached to card readers, DVD drives, floppy disk drives, and/or the like whereby media containing program code may be inserted for the purpose of loading the code onto the computer.

In accordance with the present invention, a computer may run one or more software modules designed to perform one or more of the above-described operations. Such modules might, for example, be programmed using languages such as Java, Objective C, C, C#, and/or C++ according to methods known in the art. Corresponding program code might be placed on media such as, for example, DVD, CD-ROM, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, grid computing techniques may be employed.

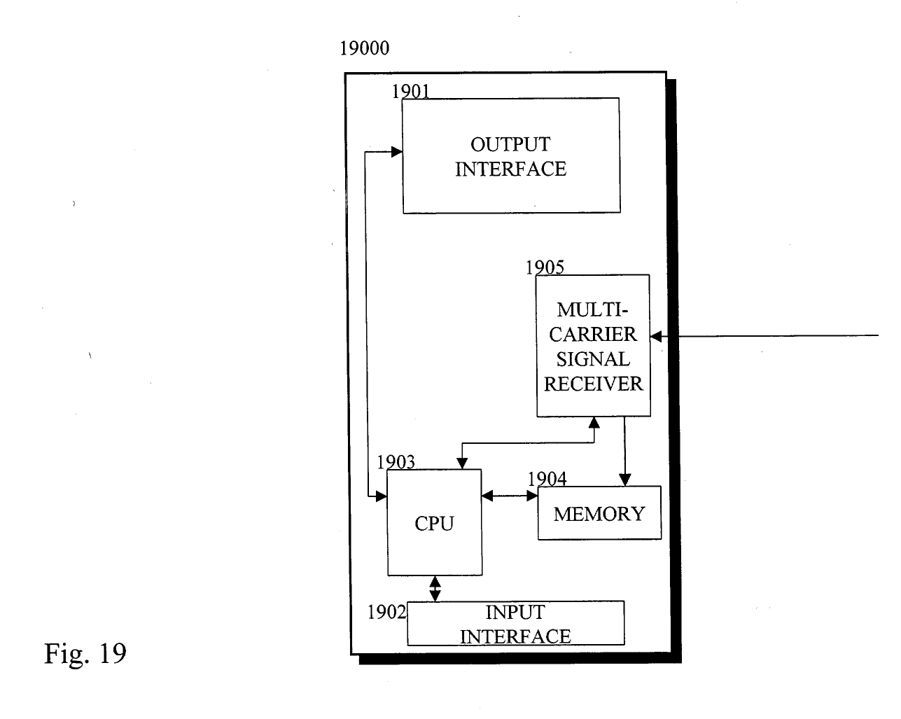

Shown in FIG. 19 is a functional block diagram of an exemplary terminal employable in various embodiments of the present invention. The terminal of FIG. 19 has been discussed in the foregoing. In the following, corresponding reference signs have been applied to corresponding parts. Terminal 19000 of FIG. 19 may be used in any/all of the embodiments described herein. The terminal 19000 comprises a processing unit CPU 1903, a multi-carrier signal terminal part 1905 and a user interface (1901, 1902). The multi-carrier signal terminal part 1905 and the user interface (1901, 1902) are coupled with the processing unit CPU 1903. One or more direct memory access (DMA) channels may exist between multi-carrier signal terminal part 1905 and memory 1904. The user interface (1901, 1902) comprises a display and a keyboard to enable a user to use the terminal 19000. In addition, the user interface (1901, 1902) comprises a microphone and a speaker for receiving and producing audio signals. The user interface (1901, 1902) may also comprise voice recognition (not shown).

The processing unit CPU 1903 comprises a microprocessor (not shown), memory 1904 and possibly software. The software can be stored in the memory 1904. The microprocessor controls, on the basis of the software, the operation of the terminal 19000, such as the receiving of the data stream, the tolerance of the impulse burst noise in the data reception, displaying output in the user interface and the reading of inputs received from the user interface. The operations are described above. The hardware contains circuitry for detecting the signal, circuitry for demodulation, circuitry for detecting the impulse, circuitry for blanking those samples of the symbol where significant amount of impulse noise is present, circuitry for calculating estimates, and circuitry for performing the corrections of the corrupted data.

Still referring to FIG. 19, alternatively, middleware or software implementation can be applied. The terminal 19000 can be a hand-held device which the user can comfortably carry. Advantageously, the terminal 19000 can be a cellular mobile phone which comprises the multi-carrier signal terminal part 1905 for receiving the multicast transmission stream. Therefore, the terminal 19000 may possibly interact with the service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method for facilitating sharing in a peer-to-peer environment, comprising:
providing an interface employable by a user in selecting one or more entities to share with others, wherein each of said one or more entities is associated with characterizing metadata; and
providing an interface employable by said user in specifying one or more peer groups with respect to which said one or more entities should be shared.

2. The method of claim 1, wherein one or more of said entities are media items.

3. The method of claim 1, wherein one or more of said entities are program files.

4. The method of claim 1, further comprising providing an interface employable by said user in associating further metadata with one or more of said entities by providing information regarding said one or more of said entities.

5. The method of claim 1, wherein said user specifies one or more recipients in said one or more peer groups.

6. The method of claim 1, wherein said interfaces are graphical user interfaces.

7. The method of claim 1, further comprising providing an interface employable by said user in viewing indications corresponding to entities shared with others.

8. The method of claim 1, further comprising providing an interface employable by said user in explicitly blocking sharing of an entity.

9. The method of claim 1, further comprising providing an interface employable by said user in creating a new group.

10. The method of claim 1, further comprising providing an interface employable by said user in requesting dispatch of a group invitation.

11. The method of claim 1, further comprising providing to said user, with respect to one or more of said entities, one or more of cost-related information and bandwidth-related information.

12. The method of claim 1, further comprising dispatching one or more of said entities to a requesting node in response to said requesting node authenticating itself as a member of one or more of said peer groups.

13. The method of claim 12, wherein authenticating comprises said requesting node providing one or more certificates indicating membership in said one or more of said peer groups.

14. The method of claim 12, wherein authenticating comprises public key infrastructure key exchange.

15. The method of claim 12, wherein authenticating includes multiple levels.

16. The method of claim 15, wherein one or more of said multiple levels is selectable depending on peer group membership.

17. The method of claim 1, further comprising dispatching one or more of said entities to a node belonging to one or more of said peer groups in the case where said node is determined to be nearby.

18. A method for facilitating searching in a peer-to-peer environment, comprising:
providing an interface employable by a user in indicating a desire to search for entities;
providing an interface employable by said user can in specifying metadata corresponding to said search;
providing an interface employable by said user in specifying one or more network interfaces to employ; and
providing an interface employable by said user in indicating one or more criteria for searching.

19. The method of claim 18, wherein one or more of said entities are receivable entities.

20. The method of claim 18, wherein one or more of said entities are group members.

21. The method of claim 18, wherein said entities are groups.

22. The method of claim 18, wherein said one or more criteria include a time and date for commencing searching.

23. The method of claim 18, wherein said one or more criteria include at least one of a cost limitation and a bandwidth limitation.

24. The method of claim 18, wherein said interfaces are graphical user interfaces.

25. The method of claim 18, further comprising providing an interface employable by said user in browsing recently-received entities.

26. The method of claim 25, wherein said recently-received entities are displayed categorically by group.

27. The method of claim 18, wherein said user can save said metadata for future searching.

28. The method of claim 18, further comprising providing an interface employable by said user in viewing data corresponding to group members.

29. The method of claim 18, further comprising providing an interface employable by said user in joining a group.

30. The method of claim 29, wherein said interface employable by said user in joining said group allows said user to receive an invitation for said group.

31. A method for entity access in a peer-to-peer environment, comprising:
informing a user of an entity available for receipt in a peer-to-peer group, wherein said entity is available through one or more authenticated connections to one or more nodes belonging to said peer-to-peer group; and
informing said user, with respect to said entity, of at least one of a corresponding cost and a corresponding bandwidth.

32. The method of claim 31, wherein one or more graphical indicators are employed in informing said user, with respect to said entity, of at least one of said corresponding cost and said corresponding bandwidth.

33. The method of claim 31, wherein said corresponding cost is a cost incurred by a user other than said user.

34. The method of claim 31, wherein said corresponding cost is a cost incurred by said user.

35. The method of claim 31, wherein multiple network hops are required to receive said entity, and said corresponding cost is a total cost for receiving said entity via said hops.

36. The method of claim 31, wherein multiple network hops are required to receive said entity, and said corresponding bandwidth is an average bandwidth for receiving said entity via said hops.

37. The method of claim 31, wherein there are multiple alternatives for receiving said entity, and said user is informed of a cost corresponding to each of one or more of said alternatives.

38. The method of claim 31, wherein there are multiple alternatives for receiving said entity, and said user is informed of a utilization of bandwidth corresponding to each of one or more of said alternatives.

39. The method of claim 31, wherein said connections are authenticated by providing one or more certificates indicating membership in said peer-to-peer group.

40. A system for facilitating sharing in a peer-to-peer environment, comprising:
a memory having program code stored therein; and
a processor operatively connected to said memory for carrying out instructions in accordance with said stored program code;
wherein said program code, when executed by said processor, causes said processor to perform:
providing an interface employable by a user in selecting one or more entities to share with others, wherein each of said one or more entities is associated with characterizing metadata; and
providing an interface employable by said user in specifying one or more peer groups with respect to which said one or more entities should be shared.

41. The system of claim 40, wherein one or more of said entities are media items.

42. The system of claim 40, wherein one or more of said entities are program files.

43. The system of claim 40, wherein said processor further performs providing an interface employable by said user in associating further metadata with one or more of said entities by providing information regarding said one or more of said entities.

44. The system of claim 40, wherein said user specifies one or more recipients in said one or more peer groups.

45. The system of claim 40, wherein said interfaces are graphical user interfaces.

46. The system of claim 40, wherein said processor further performs providing an interface employable by said user in viewing indications corresponding to entities shared with others.

47. The system of claim 40, wherein said processor further performs providing an interface employable by said user in explicitly blocking sharing of an entity.

48. The system of claim 40, wherein said processor further performs providing an interface employable by said user in creating a new group.

49. The system of claim 40, wherein said processor further performs providing an interface employable by said user in requesting dispatch of a group invitation.

50. The system of claim 40, wherein said processor further performs providing to said user, with respect to one or more of said entities, one or more of cost-related information and bandwidth-related information.

51. The system of claim 40, wherein said processor further performs dispatching one or more of said entities to a requesting node in response to said requesting node authenticating itself as a member of one or more of said peer groups.

52. The system of claim 51, wherein authenticating comprises said requesting node providing one or more certificates indicating membership in said one or more of said peer groups.

53. The system of claim 51, wherein authenticating comprises public key infrastructure key exchange.

54. The system of claim 51, wherein authenticating includes multiple levels.

55. The system of claim 54, wherein one or more of said multiple levels is selectable depending on peer group membership.

56. The system of claim 40, wherein said processor further performs dispatching one or more of said entities to a node belonging to one or more of said peer groups in the case where said node is determined to be nearby.

57. A system for facilitating searching in a peer-to-peer environment, comprising:
a memory having program code stored therein; and
a processor operatively connected to said memory for carrying out instructions in accordance with said stored program code;
wherein said program code, when executed by said processor, causes said processor to perform:
providing an interface employable by a user in indicating a desire to search for entities;
providing an interface employable by said user can in specifying metadata corresponding to said search;
providing an interface employable by said user in specifying one or more network interfaces to employ; and
providing an interface employable by said user in indicating one or more criteria for searching.

58. The system of claim 57, wherein one or more of said entities are receivable entities.

59. The system of claim 57, wherein one or more of said entities are group members.

60. The system of claim 57, wherein said entities are groups.

61. The system of claim 57, wherein said one or more criteria include a time and date for commencing searching.

62. The system of claim 57, wherein said one or more criteria include at least one of a cost limitation and a bandwidth limitation.

63. The system of claim 57, wherein said interfaces are graphical user interfaces.

64. The system of claim 57, wherein said processor further performs providing an interface employable by said user in browsing recently-received entities.

65. The system of claim 64, wherein said recently-received entities are displayed categorically by group.

66. The system of claim 57, wherein said user can save said metadata for future searching.

67. The system of claim 57, wherein said processor further performs providing an interface employable by said user in viewing data corresponding to group members.

68. The system of claim 57, wherein said processor further performs providing an interface employable by said user in joining a group.

69. The system of claim 68, wherein said interface employable by said user in joining said group allows said user to receive an invitation for said group.

70. A system for entity access in a peer-to-peer environment, comprising:
a memory having program code stored therein; and
a processor operatively connected to said memory for carrying out instructions in accordance with said stored program code;
wherein said program code, when executed by said processor, causes said processor to perform:
informing a user of an entity available for receipt in a peer-to-peer group, wherein said entity is available through one or more authenticated connections to one or more nodes belonging to said peer-to-peer group; and
informing said user, with respect to said entity, of at least one of a corresponding cost and a corresponding bandwidth.

71. The system of claim 70, wherein one or more graphical indicators are employed in informing said user, with respect to said entity, of at least one of said corresponding cost and said corresponding bandwidth.

72. The system of claim 70, wherein said corresponding cost is a cost incurred by a user other than said user.

73. The system of claim 70, wherein said corresponding cost is a cost incurred by said user.

74. The system of claim 70, wherein multiple network hops are required to receive said entity, and said corresponding cost is a total cost for receiving said entity via said hops.

75. The system of claim 70, wherein multiple network hops are required to receive said entity, and said corresponding bandwidth is an average bandwidth for receiving said entity via said hops.

76. The system of claim 70, wherein there are multiple alternatives for receiving said entity, and said user is informed of a cost corresponding to each of one or more of said alternatives.

77. The system of claim 70, wherein there are multiple alternatives for receiving said entity, and said user is informed of a utilization of bandwidth corresponding to each of one or more of said alternatives.

78. The system of claim 70, wherein said connections are authenticated by providing one or more certificates indicating membership in said peer-to-peer group.
